(19) United States
(12) Patent Application Publication
(10) Pub. No.: US 2025/0149895 A1
(43) Pub. Date: May 8, 2025

(54) ELECTRIC POWER SYSTEM MANAGEMENT SYSTEM AND ELECTRIC POWER SYSTEM MANAGEMENT METHOD

(71) Applicant: Hitachi, Ltd., Tokyo (JP)

(72) Inventors: Sayan DUTTA, Tokyo (JP); Masanori ABE, Tokyo (JP); Daiki NISHIMURA, Tokyo (JP); Yasuyuki TADA, Tokyo (JP)

(21) Appl. No.: 18/922,666

(22) Filed: Oct. 22, 2024

(30) Foreign Application Priority Data
Nov. 2, 2023 (JP) 2023-188805

(51) Int. Cl. H02J 3/38; G05B 15/02; H02J 3/00

(52) U.S. Cl. CPC H02J 3/38; G05B 15/02; H02J 3/001; H02J 3/003; H02J 3/004; H02J 2203/20; H02J 2300/24; H02J 2300/28

(57) ABSTRACT

An electric power system management device generates a plan for connection of a renewable energy power supply indicating an electric power system equipment plan satisfying a predetermined constraint. A renewable energy power generation potential amount calculation unit divides a plan target region into mesh areas and analyzes region feature information related to each mesh area to calculate an electric power amount that is to be generated in each mesh area. A renewable energy power generation potential amount bus integration unit calculates a power generation potential amount of a bus when the renewable energy power supply is connected to the bus satisfying a predetermined distance standard for each mesh area, and system renewable energy power generation possible amount information indicating a generation possible amount of the system plan and an emission amount is generated by performing an optimization calculation to maximize the renewable energy power generation amount for the system plan.

### CROSS-REFERENCE TO RELATED APPLICATIONS

The present application claims priority to Japanese Patent Application No. 2023-188805, filed Nov. 2, 2023. The contents of this application are incorporated herein by reference in their entirety.

### TECHNICAL FIELD

The present invention relates to an electric power system management system and an electric power system management method.

### BACKGROUND ART

In an electric power system, an infrastructure of an electric power transmission network is forced to be reconstructed due to aging of existing equipment and introduction and expansion of a renewable energy power supply. Among these, it is a major problem for an electric power company to maximize efficiency of equipment investment while ensuring reliability of an electric power system.

In the related art, a proposal is made for the purpose of determining a prediction error of an electric power generation amount of a power supply (renewable energy power supply) using renewable energy sources (RES) in an electric power system.

For example, JP2018-506258A discloses a technique that “a system for determining (a) prediction error and/or (b) scaling error of wind generation is provided. The system uses a generation time series and a prediction time series for power generation derived from the wind to analyze a temporal correlation in a fluctuation of the wind, and quantifies (a) the prediction error defined by a deviation between high-frequency components of the prediction time series and the generation time series, and (b) the scaling error defined by a degree that the temporal correlation is not predicted for an accurate predictor of the fluctuation of the wind. The wind fluctuation may exhibit a multi-fractal behavior at a turbine level, and/or can be corrected to a fractal structure at a power network level. The prediction error and the scaling error can be reduced using a memory kernel.

### SUMMARY OF INVENTION

### Technical Problem

In recent years, with an increase in demand for clean energy, introduction of a renewable energy power supply into an electric power system is expanding. Since an electric power amount generated by the renewable energy power supply fluctuates due to various factors such as sunlight hours and wind directions, a supply to the electric power system is likely to be unstable. Therefore, there is a concern related to stability of the electric power system due to the spread of the renewable energy power supply.

Under such circumstances, the electric power company is faced with a challenge of expanding an installation of the renewable energy sources that can supply electric power suitable for a fluctuating electric power demand, while taking into account profitability within a limited budget. On the other hand, a transmission system operator or the like who manages an electric power system is required to develop an electric power system plan which ensures stability of the electric power system and compliance with an environmental standard while expanding introduction of the renewable energy power supply.

As described above, developing a plan to maximize a connection amount of the renewable energy power supply to the electric power system, while also installing and removing equipment such as transmission lines in appropriate locations and at appropriate timings to meet electric power supply or demand whose fluctuation is difficult to predict, is a major economic burden in managing the electric power system.

In JP2018-506258A, a method for acquiring and reducing the prediction error of an electric power generation amount due to, for example, renewable power generation such as wind generation is studied, but it is not assumed to create an electric power system plan in consideration of stability of the entire electric power system, an emission amount of greenhouse gases, and an economical burden on a power business operator.

Therefore, an object of the present disclosure is to provide an electric power system management unit capable of generating an electric power system plan for maximizing a connection amount of a renewable energy power supply while ensuring stability of an electric power system and compliance with an environmental standard.

### Solution to Problem

In order to solve the above problems, one representative electric power system management system according to the invention is an electric power system management system including: an electric power system management device configured to generate an electric power system plan for an electric power system; and a user terminal connected to the electric power system management device via a communication network. The electric power system management device includes a processor, a memory, and a storage unit. The storage unit includes existing equipment information indicating existing equipment in a plan target region of the electric power system, new equipment information indicating a candidate of new equipment in the plan target region of the electric power system, equipment failure information indicating a situation of an equipment failure that occurs in the electric power system, electric power supply scenario information indicating a prediction of an electric power supply to the electric power system, electric power demand scenario information indicating a prediction of an electric power demand to the electric power system, renewable energy connection request information indicating a renewable energy power supply requested to be connected to the electric power system, emission amount information indicating an emission amount of a greenhouse gas by the electric power system, electric power system bus information indicating an existing bus in the electric power system, and region feature information indicating a feature of the plan target region, and the memory includes processing instructions for causing the processor to function as a system plan generation unit that generates system plan information indicating an electric power system equipment plan satisfying a predetermined electric power supply constraint and satisfying a predetermined realizability constraint in a target period based on the existing equipment information, the new equipment information, the equipment failure information, the electric power supply scenario information, the electric power demand scenario information, and the renewable energy connection request information, a renewable energy power generation potential amount calculation unit that divides the plan target region into a plurality of mesh areas and analyzes the region feature information related to each mesh area to generate renewable energy power generation potential amount information indicating an electric power amount that is allowed to be generated by a renewable energy power supply in each mesh area, a renewable energy power generation potential amount bus integration unit that integrates, based on the system plan information, the electric power system bus information, and the renewable energy power generation potential amount information, a power generation potential amount when the renewable energy power supply is connected to a bus satisfying a predetermined distance standard for each mesh area, and calculates the power generation potential amount of the bus, and a system renewable energy power generation possible amount evaluation unit that generates, based on the emission amount information and the power generation potential amount of the bus, system renewable energy power generation possible amount information indicating a system renewable energy power generation possible amount of the system plan and an emission amount according to the system plan by performing an optimization calculation to maximize the renewable energy power generation amount for the system plan in the system plan information, and outputs the system renewable energy power generation possible amount information to the user terminal.

### Advantageous Effects of Invention

According to the present disclosure, it is possible to provide an electric power system management unit capable of generating an electric power system plan for maximizing a connection amount of a renewable energy power supply while ensuring stability of an electric power system and compliance with an environmental standard.

Problems, configurations, and effects other than those described above will be made clear by the following description of embodiments for carrying out the invention.

### BRIEF DESCRIPTION OF DRAWINGS

FIG. 1 is a diagram showing a computer system for implementing an embodiment of the present disclosure.

FIG. 2 is a diagram showing an example of a configuration of an electric power system management system according to the embodiment of the present disclosure.

FIG. 3 is a diagram showing a flow of a process in the electric power system management system according to the embodiment of the present disclosure.

FIG. 4 is a flowchart showing an overall flow of an electric power system management method according to the embodiment of the present disclosure.

FIG. 5 is a flowchart showing an example of a flow of a system plan generation process according to the embodiment of the present disclosure.

FIG. 6 is a flowchart showing an example of a flow of a renewable energy power generation potential amount calculation process according to the embodiment of the present disclosure.

FIG. 7 is a flowchart showing an example of a flow of a renewable energy power generation potential amount bus integration process according to an embodiment of the present disclosure.

FIG. 8 is a diagram showing an example of a flow of a system renewable energy power generation possible amount evaluation process of system renewable energy according to the embodiment of the present disclosure.

FIG. 9 is a diagram showing an example of existing equipment information according to the embodiment of the present disclosure.

FIG. 10 is a diagram showing an example of new equipment information according to the embodiment of the present disclosure.

FIG. 11 is a diagram showing an example of equipment failure information according to the embodiment of the present disclosure.

FIG. 12 is a diagram showing an example of electric power demand scenario information according to the embodiment of the present disclosure.

FIG. 13 is a diagram showing an example of electric power supply scenario information according to the embodiment of the present disclosure.

FIG. 14 is a diagram showing an example of renewable energy sources connection request information according to the embodiment of the present disclosure.

FIG. 15 is a diagram showing an example of wind information according to the embodiment of the present disclosure.

FIG. 16 is a diagram showing an example of solar radiation information according to the embodiment of the present disclosure.

FIG. 17 is a diagram showing an example of land information according to the embodiment of the present disclosure.

FIG. 18 is a diagram showing an example of system plan information according to the embodiment of the present disclosure.

FIG. 19 is a diagram showing an example of renewable energy power generation possible amount information according to the embodiment of the present disclosure.

FIG. 20 is information showing an example of emission amount information according to the embodiment of the present disclosure.

FIG. 21 is a diagram showing an example of bus information according to the embodiment of the present disclosure.

FIG. 22 is a diagram showing an example of system renewable energy power generation possible amount information according to the embodiment of the present disclosure.

FIG. 23 is a diagram showing an example of economic evaluation information according to the embodiment of the present disclosure.

### DESCRIPTION OF EMBODIMENTS

Hereinafter, an embodiment of the invention will be described with reference to the drawings. The invention is not limited to the embodiment. In the description of the drawings, the same portions are denoted by the same reference numerals.

Terms “first”, “second”, “third”, and the like may be used to describe various elements or components in the present disclosure, and it will be understood that these elements or components are not to be limited by these terms. These terms are used only to distinguish between one element or component from another element or component. According to the invention, a first element or a component described below may be referred to as a second element or a component without departing from the teaching of the concept of the invention.

### Summary of Invention

As described above, developing a plan to maximize a connection amount of a renewable energy power supply to an electric power system, while also installing and removing equipment such as transmission lines in appropriate locations and at appropriate timings to meet electric power supply or demand whose fluctuation is difficult to predict, is a major economic burden in managing the electric power system.

In view of the problem, the present disclosure relates to generating a future-proof and reliability-compliant electric power system equipment plan. Thereafter, a plan area is divided into mesh areas, and a power generation potential amount by a renewable energy power supply is calculated using information on solar radiation and wind in each area. Thereafter, assuming that each mesh is connected to a closest bus, the power generation potential amount of the mesh is integrated to calculate the power generation potential amount of each bus. Finally, for each system plan, economic evaluations such as a system renewable energy power generation possible amount and an emission amount of the system plan are calculated by an optimization calculation for the purpose of maximizing a renewable energy power generation amount (that is, minimizing the emission amount) with a renewable energy power generation potential amount as a maximum value.

In this way, it is possible to generate an electric power system plan (which may be omitted as a “system plan” in the present disclosure) for maximizing the connection amount of the renewable energy power supply while ensuring stability of the electric power system and compliance with an environmental standard.

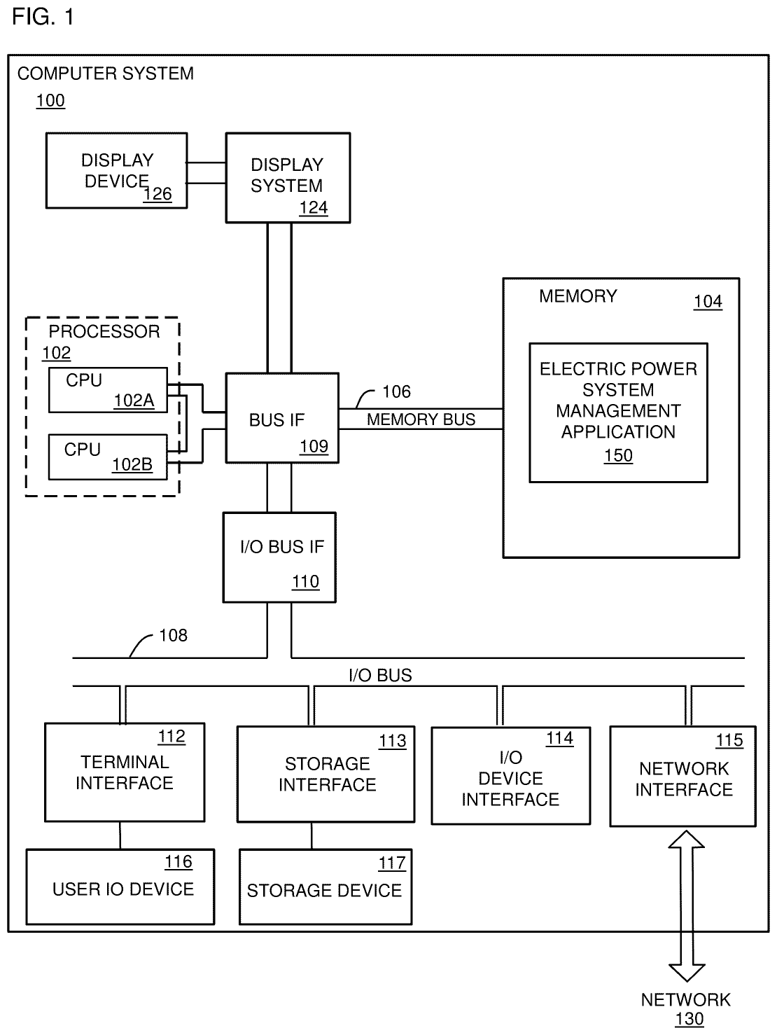

Next, a computer system 100 for implementing an embodiment of the present disclosure will be described with reference to FIG. 1. Mechanisms and devices of various embodiments disclosed in the specification may be applied to any appropriate computing system. Main components of the computer system 100 include one or more processors 102, a memory 104, a terminal interface 112, a storage interface 113, an input and output (I/O) device interface 114, and a network interface 115. These components may be mutually connected via a memory bus 106, an I/O bus 108, a bus interface unit 109, and an I/O bus interface unit 110.

The computer system 100 may include one or more general-purpose programmable central process units (CPU) 102A and 102B collectively referred to as the processor 102. In one embodiment, the computer system 100 may include a plurality of processors, or in another embodiment, computer system 100 may be a single CPU system. Each processor 102 may execute an instruction stored in the memory 104 and include an on-board cache.

In one embodiment, the memory 104 may include a random access semiconductor memory for storing data and programs, a storage device, or a storage medium (either volatile or nonvolatile). The memory 104 may store all or some of a program, a module, and a data structure for implementing functions described in the specification. For example, the memory 104 may store an electric power system management application 150. In one embodiment, the electric power system management application 150 may include an instruction or a description for executing a function described later on the processor 102.

In one embodiment, the electric power system management application 150 may be implemented by hardware via a semiconductor device, a chip, a logic gate, a circuit, a circuit card, and/or another physical hardware device, instead of a processor-based system or in addition to the processor-based system. In one embodiment, the electric power system management application 150 may include data other than instructions or descriptions. In one embodiment, a camera, a sensor, or another data input device (not shown) may be provided to directly communicate with the bus interface unit 109, the processor 102, or another hardware of the computer system 100.

The computer system 100 may include the bus interface unit 109 that performs communication between the processor 102, the memory 104, a display system 124, and the I/O bus interface unit 110. The I/O bus interface unit 110 may be coupled to the I/O bus 108 for transferring data to and from various I/O units. The I/O bus interface unit 110 may communicate with the plurality of I/O interface units 112, 113, 114, and 115 which are known as an I/O processor (IOP) or an I/O adapter (IOA) via the I/O bus 108.

The display system 124 may include a display controller, a display memory, or both. The display controller can provide video, audio, or both data to a display device 126. The computer system 100 may include one or a plurality of devices such as sensors implemented to collect data and provide the data to the processor 102.

For example, the computer system 100 may include a biological sensor that collects heart rate data, stress level data, and the like, an environmental sensor that collects humidity data, temperature data, pressure data, and the like, and a motion sensor that collects acceleration data, movement data, and the like. Sensors of other types can also be used. The display system 124 may be connected to the display device 126 such as a stand-alone display screen, a television, a tablet, or a portable device.

The I/O interface unit has a function of communicating with various storages or I/O devices. For example, a user I/O device 116, such as a user output device such as a video display device or a speaker television, or a user input device such as a keyboard, a mouse, a keypad, a touch pad, a track ball, a button, a light pen, or another pointing device, can be attached to the terminal interface unit 112. A user may input instructions or input data to the user I/O device 116 and the computer system 100 and receive output data from the computer system 100 by operating a user input device using a user interface. The user interface may be displayed on a display device via the user I/O device 116, reproduced by a speaker, or printed via a printer, for example.

One or a plurality of disk drives or a direct access storage device 117 (which is usually a magnetic disk drive storage device, but may be an array of disk drives implemented to be seen as a single disk drive or another storage device) can be attached to the storage interface 113. In one embodiment, the storage device 117 may be implemented as any secondary storage device. Contents of the memory 104 are stored in the storage device 117, and may be read from the storage device 117 as necessary. The I/O device interface 114 may provide an interface for other I/O devices such as a printer and a facsimile machine. The network interface 115 may provide a communication path so that the computer system 100 and other devices can communicate with each other. The communication path may be, for example, a network 130.

In one embodiment, the computer system 100 may be a device that receives a request from another computer system (client) without a direct user interface, such as a multi-user mainframe computer system, a single user system, or a server computer. In another embodiment, the computer system 100 may be a desktop computer, a portable computer, a notebook computer, a tablet computer, a pocket computer, a telephone, a smartphone, or any other appropriate electronic device.

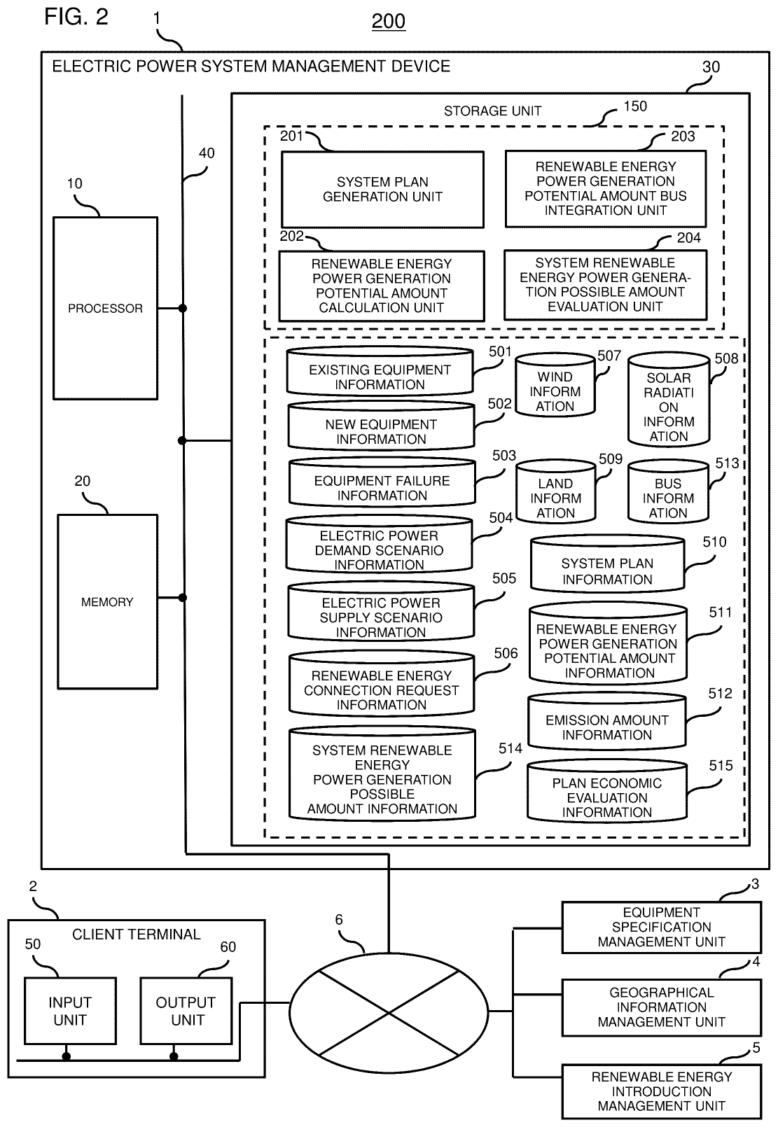

Next, a configuration of an electric power system management system according to the embodiment of the present disclosure will be described with reference to FIG. 2.

FIG. 2 is a diagram showing an example of a configuration of an electric power system management system 200 according to the embodiment of the present disclosure. The electric power system management system 200 is a system that generates an electric power system plan for maximizing the connection amount of the renewable energy power supply while ensuring the stability of the electric power system and compliance with the environmental standard, and includes, as shown in FIG. 2, an electric power system management device 1, a client terminal 2, an equipment specification management unit 3, a geographical information management unit 4, a renewable energy introduction management unit 5, and a communication network 6. The electric power system management device 1, the client terminal 2, the equipment specification management unit 3, the geographical information management unit 4, and the renewable energy introduction management unit 5 are communicably connected via the communication network 6.

The electric power system management device 1 is a device that generates the electric power system plan and provides the electric power system plan to a client such as an electric power company or an electric power system administrator, and may be a computing device such as a server device. In one embodiment, the electric power system management device 1 may be implemented as the computer system shown in FIG. 1.

As shown in FIG. 2, the electric power system management device 1 includes a processor 10, a memory 20, and a storage unit 30. The processor 10, the memory 20, and the storage unit 30 are connected to one another via an internal bus 40.

The processor 10 is a CPU that controls an operation of the electric power system management device 1 and executes functions of each functional unit described later. The memory 20 is a memory that temporarily stores data and programs. The storage unit 30 is a storage unit that stores the electric power system management application 150 that implements the functions according to the embodiment of the present disclosure and various types of information.

As shown in FIG. 2, the electric power system management application 150 includes a system plan generation unit 201 that generates the electric power system plan, a renewable energy power generation potential amount calculation unit 202 that divides a plan area into rectangular mesh areas for an electric power system equipment plan and calculates a power generation potential amount of renewable energy equipment by using information on solar radiation and wind in each area, a renewable energy power generation potential amount bus integration unit 203 that integrates the power generation potential amount assuming that the mesh is connected to a closest bus and calculates a power generation potential amount of each bus, and a system renewable energy power generation possible amount evaluation unit 204 that calculates a renewable energy power generation possible amount for the entire electric power system for each system plan.

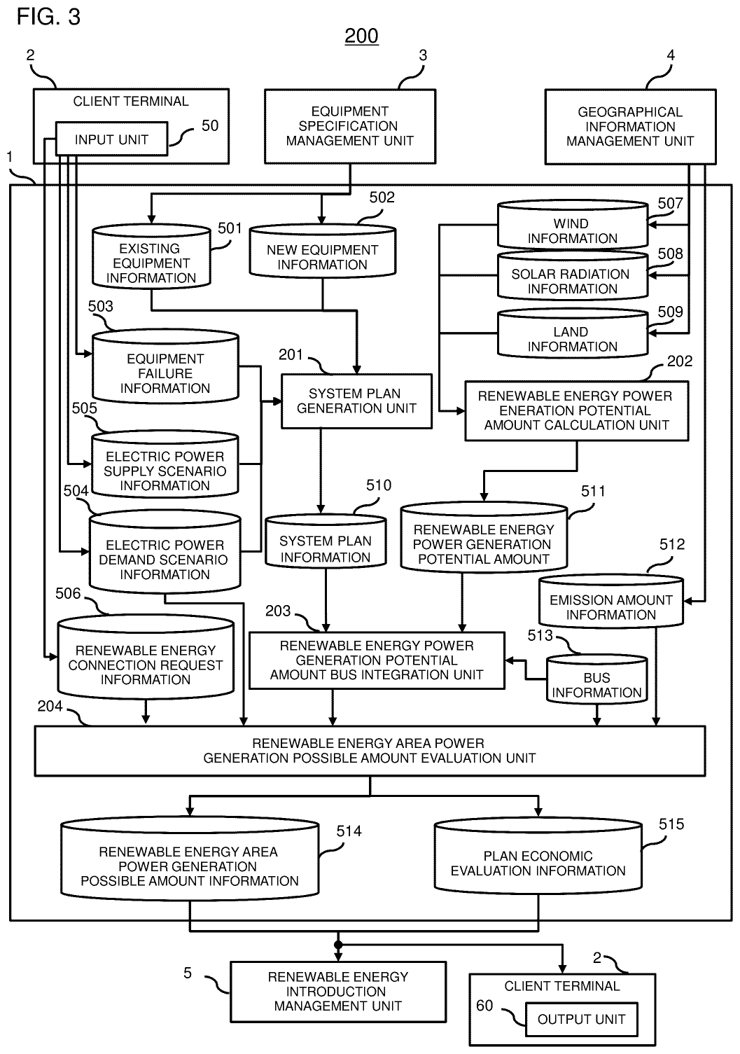

Functions of the system plan generation unit 201, the renewable energy power generation potential amount calculation unit 202, the renewable energy power generation potential amount bus integration unit 203, and the system renewable energy power generation possible amount evaluation unit 204 will be described in detail with reference to FIGS. 3 to 8, and thus a description thereof will be omitted here.

The storage unit 30 includes, as information used for generating the electric power system plan, existing equipment information 501, new equipment information 502, equipment failure information 503, electric power demand scenario information 504, electric power supply scenario information 505, renewable energy connection request information 506, wind information 507, solar radiation information 508, land information 509, system plan information 510, renewable energy power generation potential amount information 511, emission amount information 512, bus information 513, system renewable energy power generation possible amount information 514, and plan economic evaluation information 515.

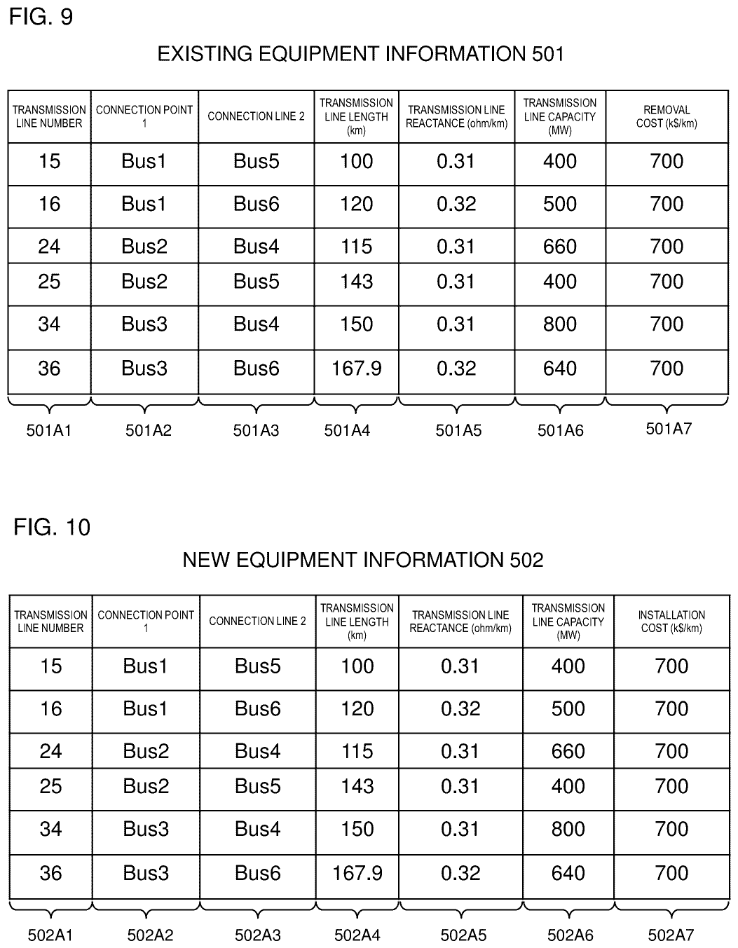

Details of the information will be described later with reference to FIGS. 9 to 23, and thus the description thereof will be omitted here.

The client terminal 2 is a terminal device used by a client that receives the electric power system plan provided by the electric power system management device 1, such as the electric power company or the electric power system administrator. As shown in FIG. 2, the client terminal 2 may include an input unit 50 such as a mouse or a keyboard for inputting information, and an output unit 60 such as a display for receiving and checking information.

The equipment specification management unit 3 is a functional unit for acquiring and storing information on equipment such as a transmission line, a substation, a bus, a transformer, and a circuit breaker in an electric power system. In one embodiment, the equipment specification management unit 3 may be, for example, a server device managed by the electric power company or the electric power system administrator and implemented to be accessible from the electric power system management device 1.

The geographical information management unit 4 is a functional unit for acquiring and storing information related to a region where each substation in the electric power system is installed. In one embodiment, the geographical information management unit 4 may acquire and manage information related to climate, an annual solar radiation amount, topography, a land use plan, and the like of a region where each substation is installed. In one embodiment, the geographical information management unit 4 may be, for example, a server device managed by the electric power company or the electric power system administrator and implemented to be accessible from the electric power system management device 1.

The renewable energy introduction management unit 5 is a functional unit for acquiring and storing information related to the maximum renewable energy sources power generation amount expected in each region where introduction of a renewable energy power supply is being studied. In one embodiment, the renewable energy introduction management unit 5 may be, for example, a server device managed by the electric power company or the electric power system administrator and implemented to be accessible from the electric power system management device 1.

According to the electric power system management system 200 implemented as described above, the electric power system management application 150 can generate the electric power system plan for maximizing the connection amount of the renewable energy power supply while ensuring stability of the electric power system and compliance with the environmental standard.

Next, a flow of a process in the electric power system management system according to the embodiment of the present disclosure will be described with reference to FIG. 3.

FIG. 3 is a diagram showing the flow of the process in the electric power system management system according to the embodiment of the present disclosure. Processing instructions for implementing the functional units constituting the electric power system management application 150 stored in the storage unit 30 are called by the memory 20 based on an execution instruction from the user and implemented by the processor 10.

First, the system plan generation unit 201 uses the existing equipment information 501, the new equipment information 502, the equipment failure information 503, the electric power demand scenario information 504, the electric power supply scenario information 505, and the renewable energy connection request information 506. By executing an optimization calculation, the system plan information 510 indicating the electric power system equipment plan that can be realized while satisfying constraints such as an electric power supply constraint and a realizability constraint of the electric power system in a target period is generated.

The electric power supply constraint here is a constraint that defines an electric power supply for maintaining the stability of the electric power system, and may be a constraint that defines a power flow of the transmission line, a power generation amount of a power generation plant, and a supply trouble power of a bus are within allowable ranges, for example, in a normal state or for each equipment failure situation.

The realizability constraint is a constraint for evaluating whether a specific electric power system equipment planning is realizable, and may be defined based on a time, a budget, a material, a personnel, and the like.

Next, the renewable energy power generation potential amount calculation unit 202 divides a plan target region into rectangular mesh areas, analyzes the wind information 507, the solar radiation information 508, and the land information 509 of each area, and generates the renewable energy power generation potential amount information 511 indicating the renewable energy power generation potential amount of each mesh in the system area.

Next, using the system plan information 510 and the renewable energy power generation potential amount information 511, the renewable energy power generation potential amount bus integration unit 203 integrates the power generation potential amount assuming that each mesh is connected to the closest bus, and calculates the power generation potential amount of each bus.

Next, using the renewable energy power generation potential amount information 511, the emission amount information 512, and the bus information 513, the system renewable energy power generation possible amount evaluation unit 204 generates, for each system plan in the system plan information 510, the system renewable energy power generation possible amount information 514 indicating the system renewable energy power generation possible amount and the emission amount of the system plan by performing the optimization calculation for the purpose of maximizing the renewable energy power generation amount (that is, minimizing the emission amount) with the renewable energy power generation potential amount as a variable having a maximum value. The system renewable energy power generation possible amount evaluation unit 204 may generate, for each system plan in the system plan information 510, the plan economic evaluation information 515 indicating various costs for performing the plan.

According to the electric power system management system 200 implemented as described above, the electric power system management application 150 can generate an electric power system plan for maximizing the connection amount of the renewable energy power generation while ensuring the stability of the electric power system and compliance with the environmental standard by calculating the maximum power generation amount of the renewable energy power supply with respect to the electric power system plan that is realizable in the future and conforms to the reliability.

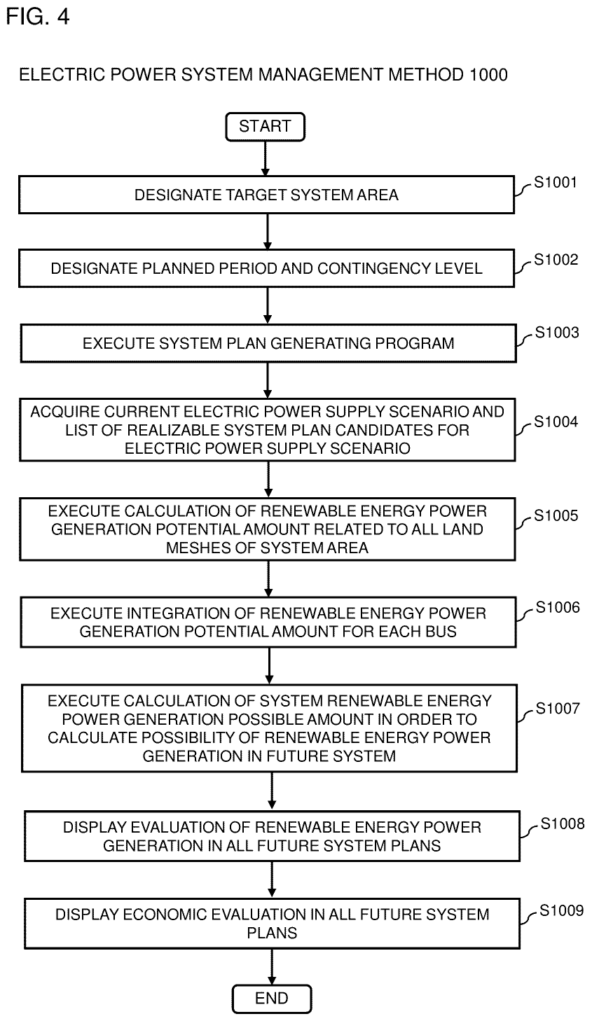

Next, an overall flow of an electric power system management method according to the embodiment of the present disclosure will be described with reference to FIG. 4.

FIG. 4 is a flowchart showing an overall flow of an electric power system management method 1000 according to the embodiment of the present disclosure. The electric power system management method 1000 is a method for generating an electric power system plan and calculating a maximum connection amount of the renewable energy power supply while ensuring the reliability of the electric power system, thereby generating an electric power system plan for maximizing the connection amount of the renewable energy power supply while ensuring the stability of the electric power system and compliance with the environmental standard, and is implemented by, for example, the system plan generation unit 201, the renewable energy power generation potential amount calculation unit 202, the renewable energy power generation potential amount bus integration unit 203, and the system renewable energy power generation possible amount evaluation unit 204 shown in FIGS. 2 and 3.

First, in step S1001, the electric power system management device 1 receives a designation from the client terminal 2 of a target area (plan target region) for generating an equipment plan.

Next, in step S1002, information such as planned years of the electric power system equipment plan and a contingency level of the equipment to be considered in the system plan is set.

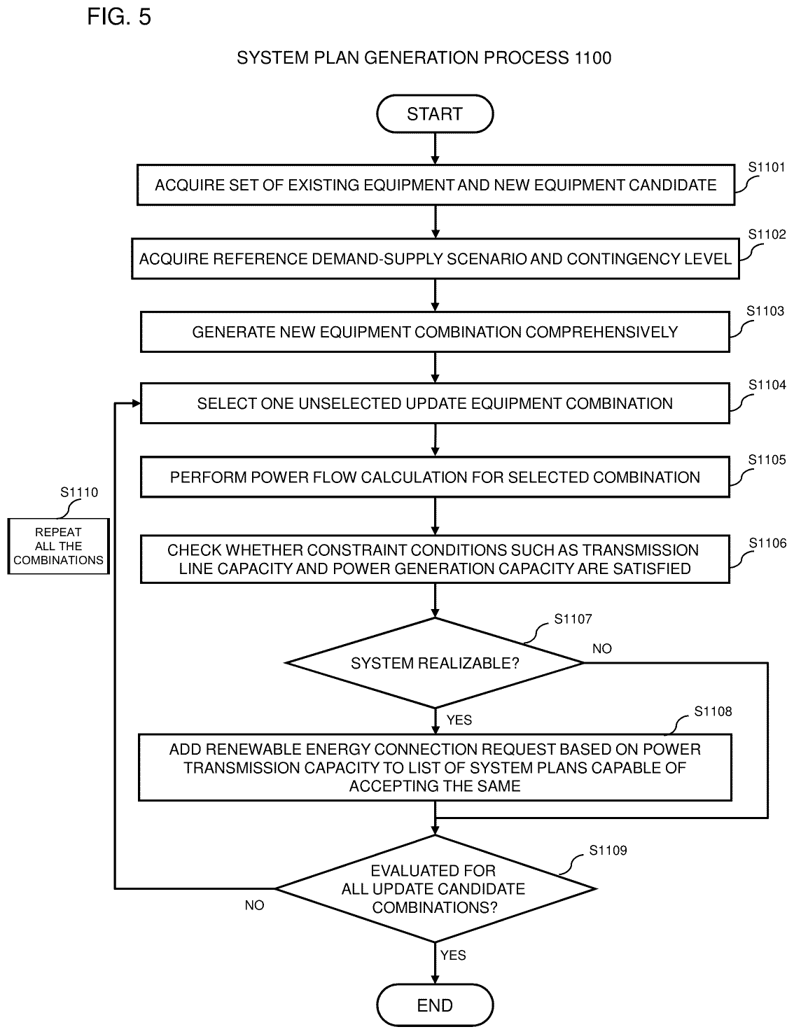

Next, in step S1003, based on the existing equipment information 501, the new equipment information 502, the equipment failure information 503, the electric power demand scenario information 504, the electric power supply scenario information 505, and the renewable energy connection request information 506, a plurality of electric power system plans are generated that are realizable in the future and conform to a reliability standard. Details of the process will be described later with reference to FIG. 5.

Here, the electric power supply scenario information 505 and the electric power demand scenario information 504 are used as a demand-supply scenario. The electric power supply scenario information 505 is information indicating an expected annual fluctuation and an occurrence probability of an electric power supply, and the electric power demand scenario information 504 is information indicating an expected annual fluctuation and an occurrence probability of an electric power demand. The existing equipment information 501 is information on existing equipment for the plan target region, and the new equipment information 502 is information indicating candidates for new equipment for the plan target region. The renewable energy connection request information 506 is, for example, information related to a renewable energy power supply to be connected in the electric power system, which is transmitted from a power generation business operator to a transmission system operator (TSO) managing the electric power system.

Next, in step S1004, the electric power supply scenario and a list of system plan candidates for the current electric power supply scenario generated in S1003 are acquired and stored in the storage unit 30 as the system plan information 510. The system plan information 510 is information that makes it possible to support a determination of an appropriate timing and a location for installation of new equipment and removal of existing equipment while reducing various costs that occur in the operation of the electric power system.

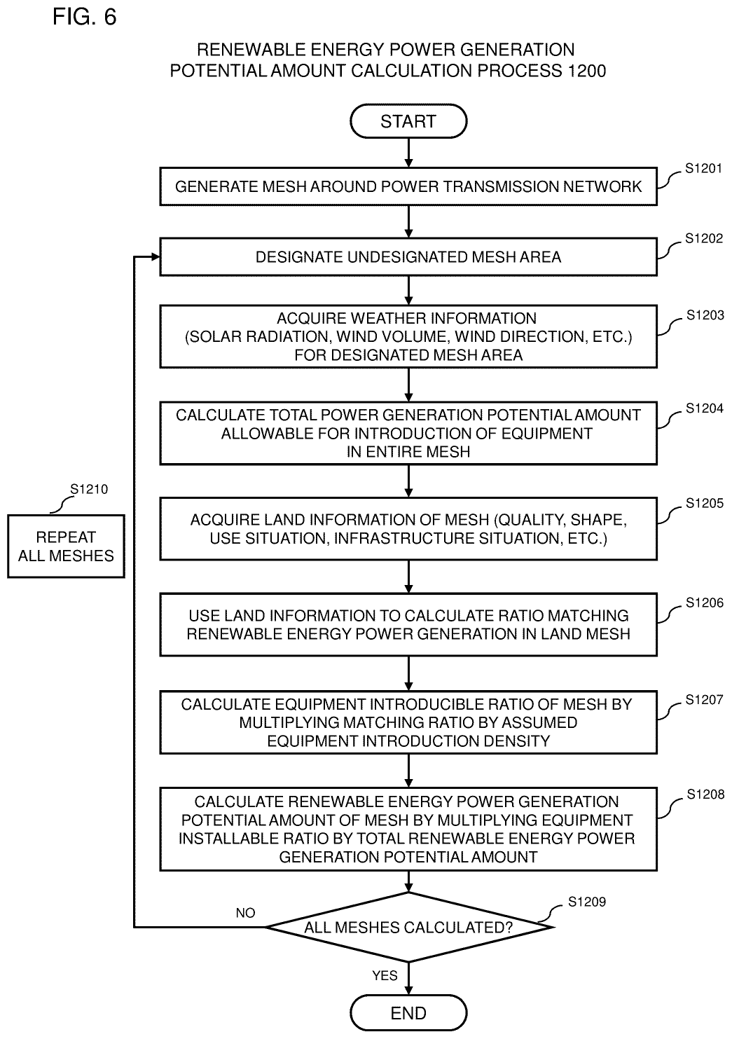

Next, in step S1005, the system area is divided into region meshes, and the renewable energy power generation potential amount is calculated using information on solar radiation and wind of each mesh. Details of the process will be described later with reference to FIG. 6.

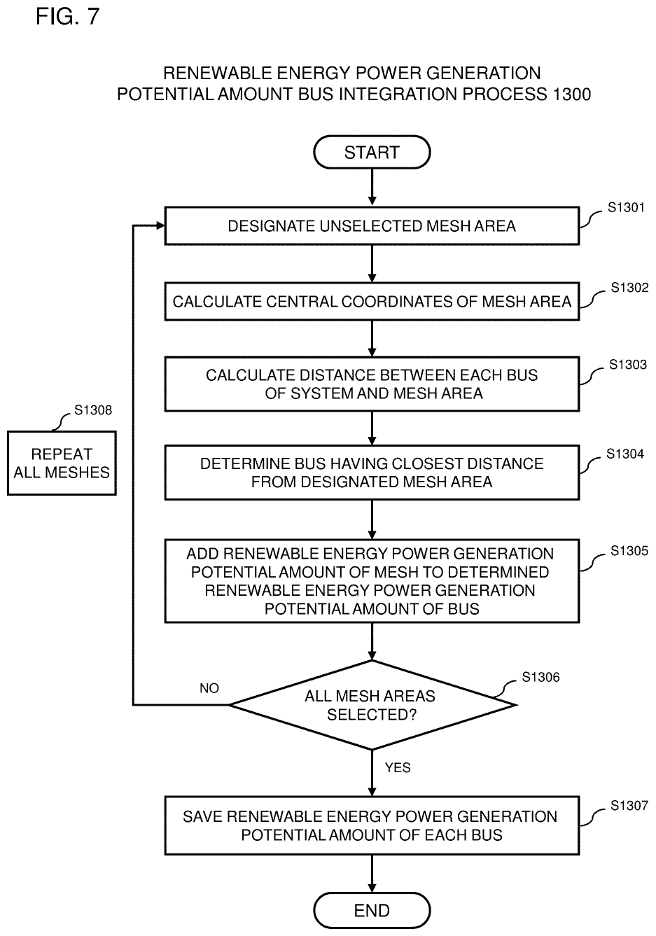

Next, in step S1006, a renewable energy power generation potential amount bus integration is executed for each bus. Details of the process will be described later with reference to FIG. 7.

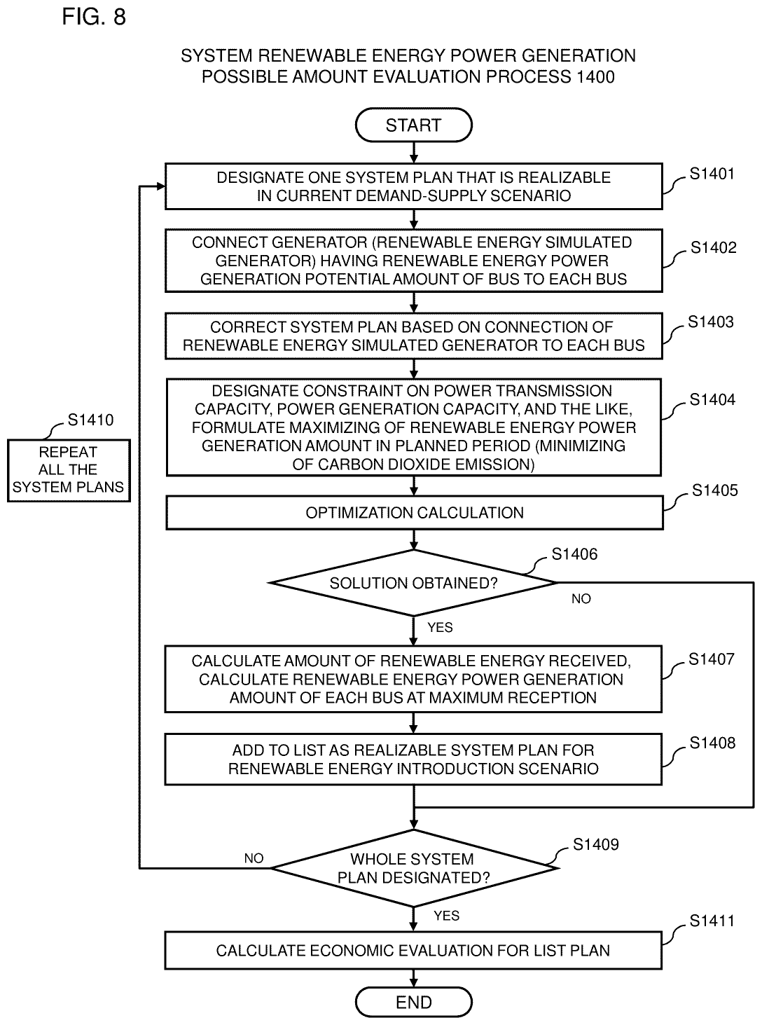

Next, in step S1007, a system renewable energy power generation possible amount calculation is executed in order to calculate the renewable energy power generation possible amount of the electric power system in each system plan. Details of the process will be described later with reference to FIG. 8.

Next, in step S1008, the information of each plan is displayed with respect to the renewable energy power generation possible amount of the electric power system in step S1007, and in step S1009, an economic evaluation such as the emission amount in each plan is displayed.

According to the electric power system management method 1000 implemented as described above, it is possible to generate the electric power system plan for maximizing the connection amount of the renewable energy power supply while ensuring the stability of the electric power system and compliance with the environmental standard by generating the electric power system plan and calculating the maximum connection amount of the renewable energy power supply while ensuring the reliability of the electric power system.

Next, a flow of a system plan generation process according to the embodiment of the present disclosure will be described with reference to FIG. 5.

The system plan generation unit 201 generates candidates for the system plan for the installation of new transmission lines over a planned year based on the existing equipment information 501, the new equipment information 502, the equipment failure information 503, the electric power demand scenario information 504, the electric power supply scenario information 505, and the renewable energy connection request information 506.

In step S1101, a set of an existing transmission line and an update candidate transmission line (also referred to as an “update equipment candidate” in the present disclosure) is generated based on the existing equipment information 501 and the new equipment information 502. The set of update candidate transmission lines here is a possible combination of removal of the existing equipment and installation of the new equipment that can satisfy the renewable energy connection request indicated in the renewable energy connection request information 506.

Next, in step S1102, a typical demand-supply scenario is generated from the electric power demand scenario information 504 and the electric power supply scenario information 505, and a contingency level is generated from the equipment failure information 503.

Next, in step S1103, new equipment combinations are comprehensively generated. Next, in step S1104, one unselected combination is selected, and in step S1105, a power flow calculation is executed for a system reflecting the selected combination.

Next, in step S1106, it is checked whether constraint conditions such as a predetermined transmission line capacity constraint and an electric power generation capacity constraint are satisfied.

Next, in step S1107, it is checked whether the system plan is realizable, and if the system plan is realizable, in step S1108, the system plan capable of accepting the renewable energy connection request based on the power transmission capacity is added to the system plan information 510. In this way, it is possible to generate the system plan information 510 indicating the system plan that can support the determination of the appropriate timing and location of the removal of the existing equipment. When checking whether the system is realizable in step S1107, a system simulating a failure according to the contingency level may be generated to additionally check whether various capacity constraints and supply trouble power conditions are satisfied.

Next, in step S1109, it is checked whether all the combinations of the new equipment are evaluated, and if a combination remains, the process is repeated until all the combinations are completed in step S1110.

Here, a specific example of the process of outputting the candidates for the system plan using the existing equipment information 501, the new equipment information 502, the equipment failure information 503, the electric power demand scenario information 504, the electric power supply scenario information 505, and the renewable energy connection request information 506 will be described. First, in S1101, the existing equipment information 501 and the new equipment information 502 are created.

In S1102, relevant input parameters are input, such as a position of a power transmission network such as “Kanagawa”, a planned year, such as “10 years”, and a contingency level, such as “N−1”.

Each combination of the new equipment (update equipment candidates) is selected, and in consideration of the electric power demand scenario information 504 and the electric power supply scenario information 505, it is checked whether the selected plan is executable in a future electric power transmission plan by the power flow calculation of the system in which the plan is reflected, and candidates for a realizable electric power transmission network plan are output. For example, a plan identifier “P1” of the output system plan information 510 and equipment measures corresponding to the plan are that a transmission line “L45 is installed” at a time “Y1” which is the first year of the planned year, and an equipment investment cost of the plan is “50000 dollars”.

According to the system plan generation process 1100 described above, it is possible to generate a plurality of electric power system plans that satisfy parameters such as designated years, and contingency levels, comply with the reliability standard, and can support the determination of a timing and a location of the installation of new equipment and the removal of existing equipment.

Next, a flow of a renewable energy power generation potential amount calculation process according to the embodiment of the present disclosure will be described with reference to FIG. 6.

FIG. 6 is a flowchart showing an example of a flow of a renewable energy power generation potential amount calculation process 1200 according to the embodiment of the present disclosure. The renewable energy power generation potential amount calculation process 1200 shown in FIG. 6 is a process of dividing the system area into mesh areas, analyzing the wind information 507, the solar radiation information 508, and the land information 509 of each area, and calculating the renewable energy power generation potential amount of each mesh in the system area, and is performed by the renewable energy power generation potential amount calculation unit 202 shown in FIGS. 2 and 3.

In step S1201, the renewable energy power generation potential amount calculation unit 202 generates a mesh of a region around the electric power system. Here, generating the mesh of the region means, for example, dividing the plan target region into a plurality of mesh areas having sections of substantially the same size and shape.

Next, in step S1202, an undesignated mesh area is designated. Next, in step S1203, information of weather information (solar radiation, wind volume, wind direction, and the like) is collected for the designated mesh. Examples of the collected information include the wind information 507 and the solar radiation information 508.

In the present disclosure, the weather information and the land information may be collectively referred to as “region feature information”.

Next, in step S1204, a total power generation potential amount that can be achieved by introducing equipment into the entire designated mesh area is calculated.

Next, in step S1205, information on land information (soil quality, topography, land use, infrastructure) is collected for the designated mesh. An example of the collected information is the land information 509.

Next, in step S1206, a matching ratio, which is a ratio matching renewable energy power generation in the region mesh, is calculated using the land information.

Next, in step S1207, an equipment introducible ratio of the mesh is calculated by multiplying the matching ratio by an assumed equipment introduction density.

Next, in step S1208, an equipment installable ratio is multiplied by the total renewable energy power generation potential amount to calculate the renewable energy power generation potential amount of the mesh.

Next, in step S1209, it is checked whether all the meshes are calculated, and if there is an uncalculated mesh area, the process is repeated until all the meshes are completed in step S1210.

Here, a specific example of a method for calculating the renewable energy power generation potential amount in a mesh of a region around the electric power system using the wind information 507, the solar radiation information 508, and the land information 509 will be described. First, a mesh ID “M3” is selected, a solar radiation amount “1400” and a capacity index “15” are used together with mesh coordinates (51.5074,−0.1278), and a potential amount of solar photovoltaic power generation is “2500”. Similarly, a potential amount of wind generation is “3500”. Accordingly, integration is performed for the designated mesh, and a potential amount of the renewable energy power generation is “6000”. The calculation is executed for all the meshes.

According to the renewable energy power generation potential amount calculation process 1200 described above, for example, it is possible to divide the plan area of the region around the electric power system into mesh areas and calculate the power generation potential amount by the renewable energy power supply by using the information on the solar radiation and the wind of each area.

Next, the renewable energy power generation potential amount bus integration process according to the embodiment of the present disclosure will be described with reference to FIG. 7.

FIG. 7 is a flowchart showing a flow of a renewable energy power generation potential amount bus integration process 1300 according to the embodiment of the present disclosure. The renewable energy power generation potential amount bus integration process 1300 shown in FIG. 7 is a process for calculating the renewable energy power generation potential amount of each bus based on the bus information 513 generated by the system plan generation process 1100 shown in FIG. 4 and the renewable energy power generation potential amount information calculated by the renewable energy power generation potential amount calculation process 1200 shown in FIG. 6, and is performed by the renewable energy power generation potential amount bus integration unit 203 shown in FIGS. 2 and 3.

In step S1301, the renewable energy power generation potential amount bus integration unit 203 designates an undesignated mesh area.

Next, in step S1302, central coordinates of the designated mesh are acquired or calculated.

Next, in step S1303, a distance between each bus of the system and the designated mesh area is calculated.

Next, in step S1304, a bus having a distance closest to the designated mesh area (that is, a bus satisfying a predetermined distance standard) is determined.

Next, in step S1305, the renewable energy power generation potential amount of the mesh is added to the determined renewable energy power generation potential amount of the bus.

Next, in step S1306, it is checked whether the calculation is performed for all the meshes.

If the determination is YES, in step S1307, the renewable energy power generation potential amount in each bus is saved. If the determination is NO, the calculation is repeated for all the mesh areas through step S1308.

Here, a specific example of a calculation result of the renewable energy power generation potential amount of each bus using the bus information 513 and the renewable energy power generation potential amount information 511 will be described. When the coordinates of a bus identifier “B7” are “(700, 1200)”, two meshes exist as the mesh closest to the bus, and the coordinates of a mesh ID “M1” are “(40.7128, 74.0060)” and the coordinates of a mesh ID “M2” are “(34.0522, 18.2437)”, potential power generation amounts are “2000” and “3500”, respectively, and thus the renewable energy power generation potential amount of a bus “B7” is 5500.

According to the renewable energy power generation potential amount bus integration process 1300 described above, for example, it is possible to calculate a potential renewable energy power generation amount that can be generated around each bus of the electric power system.

Next, a system renewable energy power generation possible amount evaluation process according to the embodiment of the present disclosure will be described with reference to FIG. 8.

FIG. 8 is a diagram showing an example of a flow of the system renewable energy power generation possible amount evaluation process 1400 according to the embodiment of the present disclosure. The system renewable energy power generation possible amount evaluation process 1400 is a process for calculating the system renewable energy power generation possible amount and the emission amount of the system plan by an optimization calculation for the purpose of maximizing the renewable energy power generation amount (that is, minimizing the emission amount) using the renewable energy power generation potential amount as a variable having a maximum value for each system plan, and is performed by the system renewable energy power generation possible amount evaluation unit 204 shown in FIGS. 2 and 3.

In step S1401, one system plan that is realizable in a current demand-supply scenario is designated.

Next, in step S1402, a generator (a renewable energy simulated generator) in which the renewable energy power generation potential amount of the bus is a maximum power generation amount is connected to each bus.

Next, in step S1403, the system plan is corrected by incorporating the renewable energy simulated generator connected in S1402, and corrected system plan information is generated. The corrected system plan information is system plan information indicating a case in which a renewable energy simulated generator corresponding to the power generation potential amount of the bus is connected to the bus.

Next, in step S1404, an optimization objective function is formulated so that the renewable energy power generation amount is maximized under a predetermined constraint such as an electric power transmission capacity constraint or an electric power generation capacity constraint.

Next, in step S1405, the optimization calculation is executed, and the objective function is solved.

Next, if a solution of the optimization calculation is obtained in step S1406, in step S1407, the renewable energy power generation possible amount at which the system plan is maximized is calculated. Here, the emission amount according to the corrected system plan information may be calculated based on the emission amount information 512 and the calculated renewable energy power generation possible amount. Thereafter, information indicating a maximum value of the calculated renewable energy power generation amount and the emission amount may be stored in the storage unit 30 as the system renewable energy power generation possible amount information 514.

Next, in step S1408, the information is added to a list as a realizable system plan for a renewable energy introduction scenario.

Next, in step S1409, it is checked whether all the system plans are designated, and if the determination is YES, in step S1411, an economic evaluation is calculated for the system plans in the list. Here, the system renewable energy power generation possible amount evaluation unit 204 may generate, for each system plan in the corrected system plan information, the plan economic evaluation information 515 indicating various costs for performing the plan, and store the information in the storage unit 30.

If the determination is NO, the calculation is repeated for all the system plans through step S1410.

Here, a specific example of calculating the system renewable energy power generation possible amount information 514 and the plan economic evaluation information 515 of each system plan using the system plan information 510 and the emission amount information 512 will be described. A plan ID “P1” is checked, an equipment measure is that “L45 is installed”, and the renewable energy power generation amount is maximized and the emission amount energy is minimized in five years of a planned year. Finally, the maximized renewable energy power generation amount is “5000” MW, and the emission amount is “1026” t.

According to the system renewable energy power generation possible amount evaluation process 1400 described above, for example, the maximum possible amount of the renewable energy power supply in each possible system plan of the electric power system can be calculated. Further, among these system plans, it is possible to easily determine which of the system plans has the maximum possible amount of the renewable energy power supply in the future and can accept the maximum number of the renewable energy power supply connection requests from a power generation company. In addition, it is possible to easily determine which of the system plans can conform to the environmental standard.

Next, various types of information used for generating the electric power system plan according to the embodiment of the present disclosure will be described with reference to FIGS. 9 to 23.

To generate an electric power system plan, it is desirable to consider the existing equipment installed in the past in the electric power system. Hereinafter, the existing equipment information 501 used by an electric power system management unit according to the embodiment of the present disclosure will be described with reference to FIG. 9. The existing equipment information 501 may be created in advance by, for example, an administrator of the electric power system management system 200 through the equipment specification management unit 3 shown in FIG. 2, and may be transmitted from the equipment specification management unit 3 to the electric power system management device 1. In one embodiment, the existing equipment information 501 may be prepared on a client side such as an electric power company and transmitted from the client terminal 2 to the electric power system management device 1.

As described above, various types of equipment are used in the electric power system, but for convenience of description, a case in which the equipment is a transmission line will be described as an example.

FIG. 9 is a diagram showing an example of the existing equipment information 501 according to the embodiment of the present disclosure. As described above, the existing equipment information 501 is information related to the existing equipment (here, the transmission line) installed in the past in the electric power system, and may include information of a transmission line number 501A1, a connection point 1 501A2, a connection point 2 501A3, a transmission line length 501A4, a transmission line reactance 501A5, a transmission line capacity 501A6, and a removal cost 501A7 as shown in FIG. 3.

The transmission line number 501A1 is information for identifying a specific transmission line. The connection point 1 501A2 is information indicating a bus number that is a start point of the power transmission line. The connection point 2 501A2 is information indicating a bus number that is an end point of the power transmission line. The transmission line length 501A4 is information indicating a distance (km) between coordinates of a bus that is a start point and a bus that is an end point of the transmission line. The transmission line reactance 501A5 is information indicating a reactance (ohm/km) of the transmission line. The transmission line capacity 501A6 is information indicating a transmittable capacity (MW) of the transmission line. If the electric power in the power transmission line is more than the power transmission line capacity, the power transmission line may be damaged or burned. The removal cost 501A7 is information indicating a removal cost (k$/km) per unit length of the transmission line.

As an example, for the transmission line with the transmission line number “24”, the connection point 1 is a bus 2, the connection point is a bus 4, the transmission line length is 115 km, the transmission line reactance is 0.31 ohm/km, the transmission line capacity is 660 MW, and the removal cost is 700 k$/km.

Here, the “bus” means a conductor to which any component in an electric power system such as a generator, a load, and a power supply line is connected. In addition, in FIG. 9, a case in which the removal cost of all the power transmission lines is “700 k$/km” is shown as an example, but the removal cost actually changes depending on a timing and a location.

The electric power system is required to cope with various situations according to fluctuations in the electric power supply and the electric power demand. In the electric power system, various costs, such as an investment cost for installing new equipment, a removal cost for removing an existing equipment, a power generation cost for generating power, and a power transmission loss cost due to power transmission loss, fluctuate depending on the timing and the location.

The electric power supply scenario information 505 and the electric power demand scenario information 504 may be collected and saved in a scenario DB (not shown) including a supply and demand scenario indicating a fluctuation in the electric power supply and a fluctuation in the electric power demand which may occur in the electric power system.

FIG. 10 is a diagram showing an example of the new equipment information 502 according to the embodiment of the present disclosure. As described above, the new equipment information 502 is information related to an equipment (here, a transmission line) that may be installed in the electric power system in the future, and may include information of a transmission line number 502A1, a connection point 1 502A2, a connection point 2 502A3, a transmission line length 502A4, a transmission line reactance 502A5, a transmission line capacity 502A6, and an installation cost 502A7 as shown in FIG. 10.

The transmission line number 502A1 is information for identifying a specific transmission line. The connection point 1 502A2 is information indicating a bus number that is a start point of the power transmission line. The connection point 2 502A2 is information indicating a bus number that is an end point of the power transmission line. The transmission line length 502A4 is information indicating a distance (km) between coordinates of a bus that is a start point and a bus that is an end point of the transmission line. The transmission line reactance 502A5 is information indicating a reactance (ohm/km) of the transmission line. The transmission line capacity 502A6 is information indicating a transmittable capacity (MW) of the transmission line. If the electric power in the power transmission line is more than the power transmission line capacity, the power transmission line may be damaged or burned. The installation cost 502A7 is information indicating an installation cost (k$/km) per unit length of the transmission line.

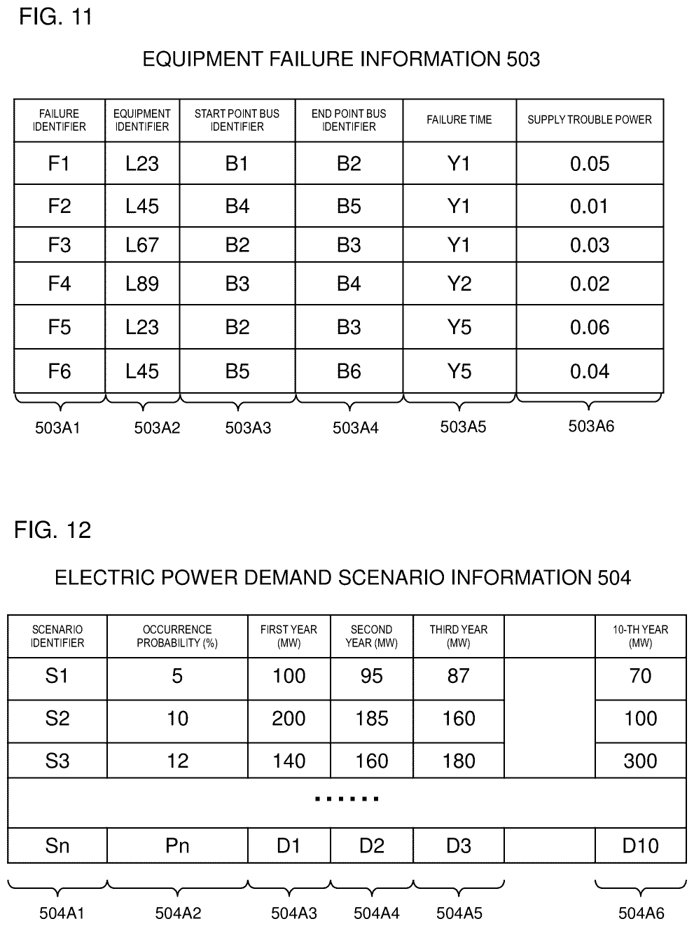

Next, the equipment failure information according to the embodiment of the present disclosure will be described with reference to FIG. 11.

FIG. 11 is a diagram showing an example of the equipment failure information 503 according to the embodiment of the present disclosure. As described above, the equipment failure information 503 is information indicating a failure state of equipment that may occur in an electric power system, and may be generated based on a contingency level input by the user. As shown in FIG. 11, the equipment failure information 503 may include a failure identifier 503A1, an equipment identifier 503A2, a start point bus identifier 503A3, an end point bus identifier 503A4, a failure time 503A5, and supply trouble power 503A6.

The failure identifier 503A1 is information for uniquely identifying a specific failure situation. The equipment identifier 503A2 is information for uniquely identifying equipment such as a power transmission line that fails in a specific failure situation. The start point bus identifier 503A3 is information indicating a bus number that is a start point of equipment such as a power transmission line. The end point bus identifier 503A4 is information indicating a bus number that is an end point of equipment such as a power transmission line. The failure time 503A5 is a planned year (a first year, a second year, a fifth year, or the like) when a specific failure situation is scheduled to occur. The supply trouble power 503A6 is information representing a maximum value of allowable supply trouble power in a specific failure situation as a percentage with respect to a total demand.

As an example, in a failure situation in which the failure identifier is “F2”, it is indicated that the equipment of “L45” having “B4” and “B5” as the start point and end point buses fails in the “first year” of an initial electric power system plan, and the failure situation in which the supply trouble power is “0.01%” of the total demand may occur.

FIG. 12 is a diagram showing an example of the electric power demand scenario information 504 according to the embodiment of the present disclosure. The electric power demand scenario information 504 is information indicating an expected annual fluctuation in the electric power demand and an occurrence probability thereof as a specific electric power demand scenario, and may include a scenario identifier 504A1, an occurrence probability 504A2 of the scenario, a fluctuation in the electric power demand in the first year 504A3, a fluctuation in the electric power demand in the second year 504A4, a fluctuation in the electric power demand in the third year 504A5, and a fluctuation in the electric power demand in the 10-th year 504A6, as shown in FIG. 11.

In FIG. 12, for convenience of description, a fluctuation in the electric power demand in the fourth to ninth years is omitted, but it is needless to say that the information is actually included in the electric power demand scenario information 504. In addition, the fluctuation in the electric power demand after the 10-th year may be included in the electric power demand scenario information 504.

For example, in a scenario in which the scenario identifier is “S2”, the occurrence probability is 10%, an increase in the electric power demand in the first year is 200 MW, an increase in the electric power demand in the second year is 185 MW, an increase in the electric power demand in the third year is 160 MW, and an increase in the electric power demand in the 10-th year is 100 MW.

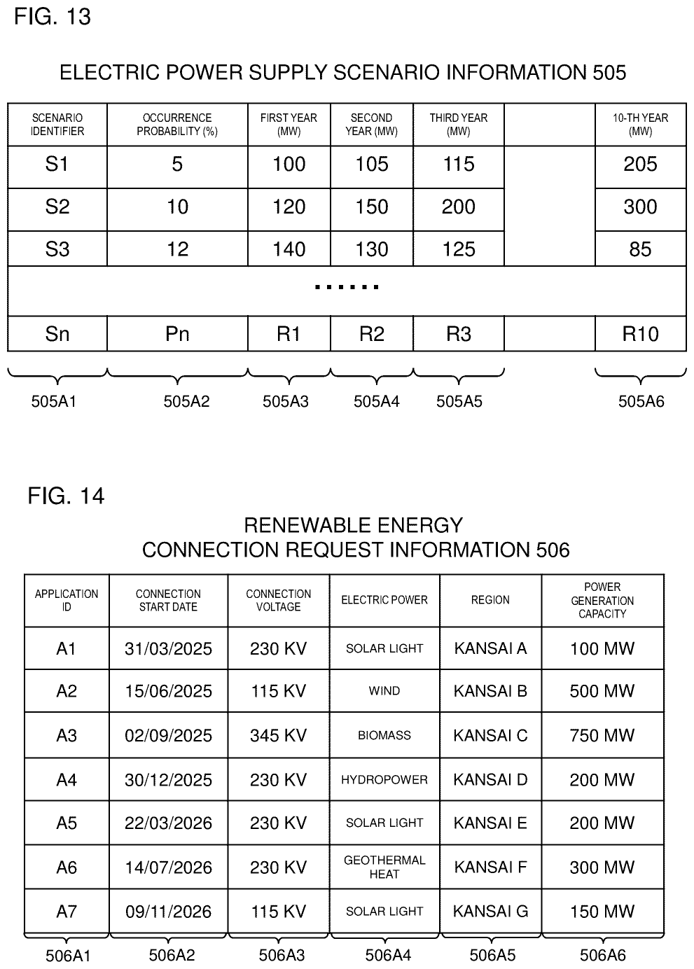

FIG. 13 is a diagram showing an example of the electric power supply scenario information 505 according to the embodiment of the present disclosure. The electric power supply scenario information 505 is information indicating an expected annual fluctuation in the electric power supply and an occurrence probability thereof as a specific electric power supply scenario, and may include a scenario identifier 505A1, an occurrence probability 505A2 of the scenario, a fluctuation in the electric power supply in the first year 505A3, a fluctuation in the electric power supply in the second year 505A4, a fluctuation in the electric power supply in the third year 505A5, and a fluctuation in the electric power supply in the 10-th year 505A6, as shown in FIG. 13.

In FIG. 13, for convenience of description, the electric power supply from the fourth year to the ninth year is omitted, but it is needless to say that this information is actually included in the electric power supply scenario information 505. In addition, the electric power supply after the 10-th year may be included in the electric power supply scenario information 505.

For example, in the scenario in which the scenario identifier is “S2”, the occurrence probability is 10%, an increase in the electric power supply in the first year is 120 MW, an increase in the electric power supply in the second year is 150 MW, an increase in the electric power supply in the third year is 200 MW, and an increase in the electric power supply in the 10-th year is 300 MW.

Next, the renewable energy connection request information according to the embodiment of the present disclosure will be described with reference to FIG. 14.

FIG. 14 is a diagram showing an example of the renewable energy connection request information 506 according to the embodiment of the present disclosure. The renewable energy connection request information 506 is, for example, information related to a renewable energy power supply to be installed in the electric power system, which is transmitted from an electric power company to a transmission system operator (TSO) managing the electric power system. According to the electric power system management unit according to the embodiment of the present disclosure, the transmission system operator who receives the renewable energy connection request information 506 from the electric power company can generate, based on the renewable energy connection request information 506, an electric power system plan that ensures the stability of the electric power system and compliance with the environmental standard while expanding the introduction of the renewable energy power supply. As shown in FIG. 14, the renewable energy connection request information 506 may include an application ID 506A1, a connection start date 506A2, a connection voltage 506A3, an electric power type 506A4, a region 506A5, and an electric power generation capacity 506A6.

The application ID A1 is information for uniquely identifying an application related to a new renewable energy power supply connection from an electric power company. The connection start date 506A2 is information indicating a desired schedule for connecting a new renewable energy power supply to the electric power system. The connection voltage 506A3 is information indicating a voltage of the transmission line that connects the renewable energy power supply and the electric power system. The electric power type 506A4 is information indicating a type of electric power (solar light, wind, hydropower, biomass, geothermal heat, or the like) generated by a new renewable energy power supply. The region 506A5 is information indicating a desired installation region of a new renewable energy power supply. The power generation capacity 506A6 is information indicating a maximum expected power generation amount of a new renewable energy power supply.

For example, a renewable energy connection request with the application ID “A1” requests connection of a new renewable energy power supply with a connection voltage of “230 KV”, an electric power type of “solar light”, and an electric power generation capacity of “100 MW” on “Mar. 31, 2025” in the region of “Kansai A”.

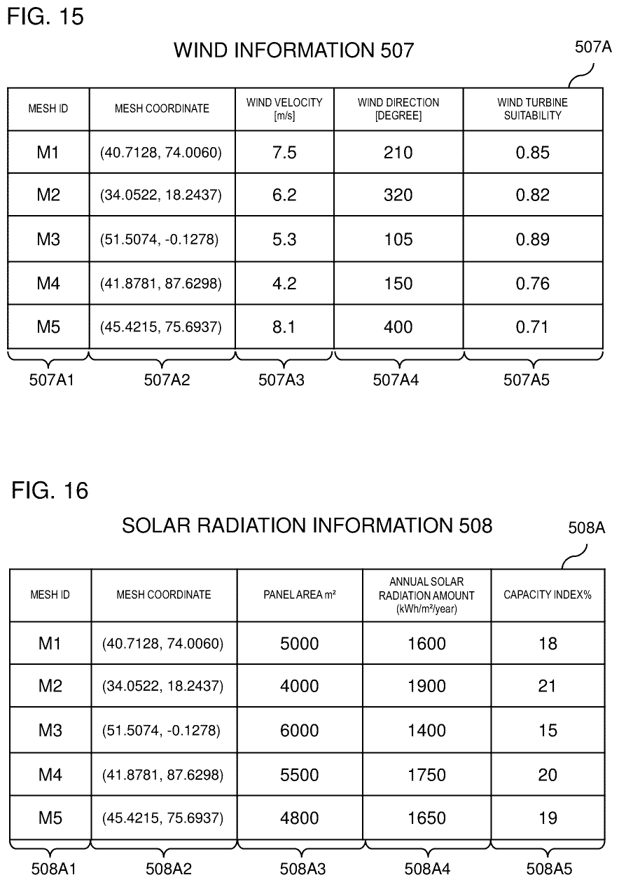

FIG. 15 is a diagram showing an example of the wind information 507 according to the embodiment of the disclosure. The wind information 507 is information related to wind conditions and wind generation in a region, and may include a mesh ID 507A1, mesh coordinates 507A2, a wind velocity 507A3, a wind direction 507A4, and a wind turbine suitability 507A5 as shown in FIG. 15.

The mesh ID 507A1 is information for uniquely identifying a mesh region (also referred to as a mesh area) of a target electric power system. The mesh coordinates 507A2 are information indicating geographical coordinates of a mesh region. The wind velocity 507A3 is an average wind velocity measured at a specific altitude in the mesh region, and a unit thereof is m/s or the like. The wind direction 507A4 is a main wind direction in a mesh region, and is expressed in units of clockwise degrees with north as a reference. The wind turbine suitability 507A5 is an index indicating a degree of suitability for installation of a wind turbine in a mesh region.

As an example, for the mesh area with the mesh ID “M1”, coordinates thereof are “(40.7128, 74.0060)”, the average wind velocity is “7.5” m/s, the wind direction is “210” degrees, and the wind turbine suitability is “0.85” of the topography.

FIG. 16 is a diagram showing an example of the solar radiation information 508 according to the embodiment of the disclosure. As shown in FIG. 16, the solar radiation information 508 is information related to solar radiation in a region, and may include a mesh ID 508A1, mesh coordinates 508A2, a panel area 508A3, a solar radiation amount 508A4, and a capacity index 508A5.

The mesh ID 508A1 is information for uniquely identifying a mesh region (also referred to as a mesh area) of a target electric power system. The mesh coordinates 508A2 are information indicating geographical coordinates of a mesh region. The panel area 508A3 is an area of a solar photovoltaic power generation panel in a mesh region, and a unit thereof is m². The solar radiation amount 508A4 is an amount of radiant energy received from solar radiation per unit area in a mesh region in one year, and is expressed in units of kWh/m²·year or the like. The capacity index 508A5 is an index indicating efficiency and reliability of renewable energy power generation equipment in a mesh region, and is represented by percentage or the like.

For example, for the mesh area with the mesh ID “M1”, coordinates thereof are “(40.7128, 74.0060)”, the panel area is “5000” m², the annual solar radiation amount is “1600” kWh/m² year, and the capacity index is “18%” of the topography.

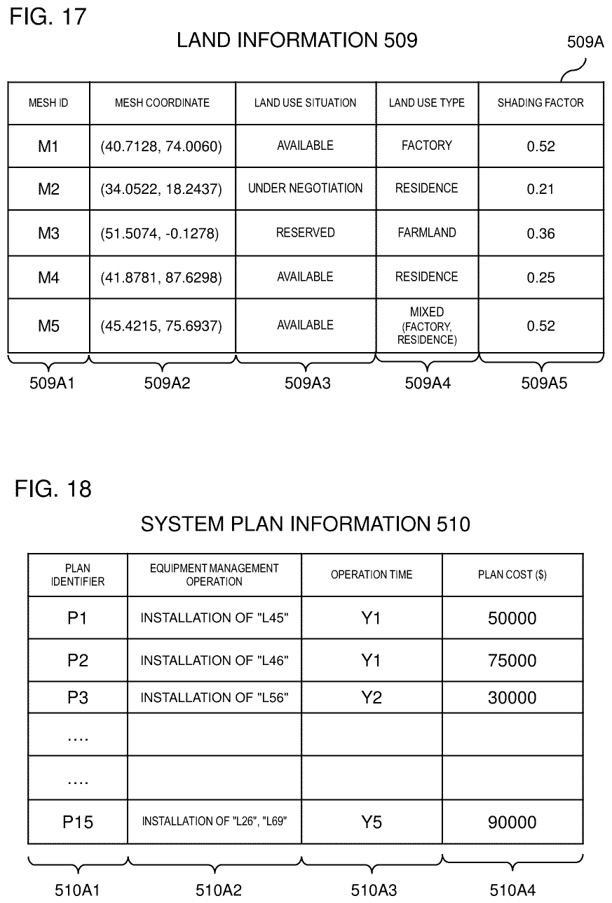

FIG. 17 is a diagram showing an example of the land information 509 according to the embodiment of the disclosure. As shown in FIG. 17, the land information 509 is information related to a topography and a use situation of the land in a region, and may include a mesh ID 509A1, mesh coordinates 509A2, a land use situation 509A3, a land use type 509A4, and a shading factor 509A5.

The mesh ID 509A1 is information for uniquely identifying a mesh region (also referred to as a mesh area) of a target electric power system. The mesh coordinates 509A2 are information indicating geographical coordinates of a mesh region. The land use situation 509A3 is information indicating a current situation related to whether renewable energy power generation can be installed in a mesh region, and indicates a situation of “available”, “under negotiation”, or “reserved”. The land use type 509A4 is information related to regulation and allocation of land use for a mesh region, and indicates a factory region, a farmland, a residence region, and other categories. The shading factor 509A5 is information indicating a degree of correction related to a decrease in solar radiation in relation to surrounding equipment or topography in a mesh region.

As an example, for the mesh area with the mesh ID “M1”, the coordinates thereof are “(40.7128, 74.0060)”, the land use situation is “available”, the land use type is “factory”, and the shading factor is “0.52” of the topography.

Next, the system plan information according to the embodiment of the present disclosure will be described with reference to FIG. 18.

FIG. 18 is a diagram showing an example of the system plan information 510 according to the embodiment of the present disclosure. As described above, the system plan information 510 is information indicating an electric power system plan that can support a determination of an appropriate timing and a location for the installation of new equipment and the removal of existing equipment while reducing various costs that occur in the operation of the electric power system, and is generated by the system plan generation process 1100 shown in FIG. 5. As shown in FIG. 18, the system plan information 510 may include a plan identifier 510A1, an equipment management operation 510A2, an operation time 510A3, and a plan cost 510A4.

The plan identifier 510A1 is information for uniquely identifying a specific electric power system plan. The equipment management operation 510A2 is information indicating a content of an operation related to equipment in a specific electric power system plan (for example, installation or removal of a specific transmission line). The operation time 510A3 is information representing a timing of the specific equipment management operation 510A2 in a planned year. The plan cost 510A4 is information indicating a cost required for the specific equipment management operation 510A2 in predetermined currency such as dollar or yen.

As an example, for the specific electric power system plan with the plan identifier of “P1”, equipment of “L45” is installed in the “first year”, and the cost thereof is “$50,000”.

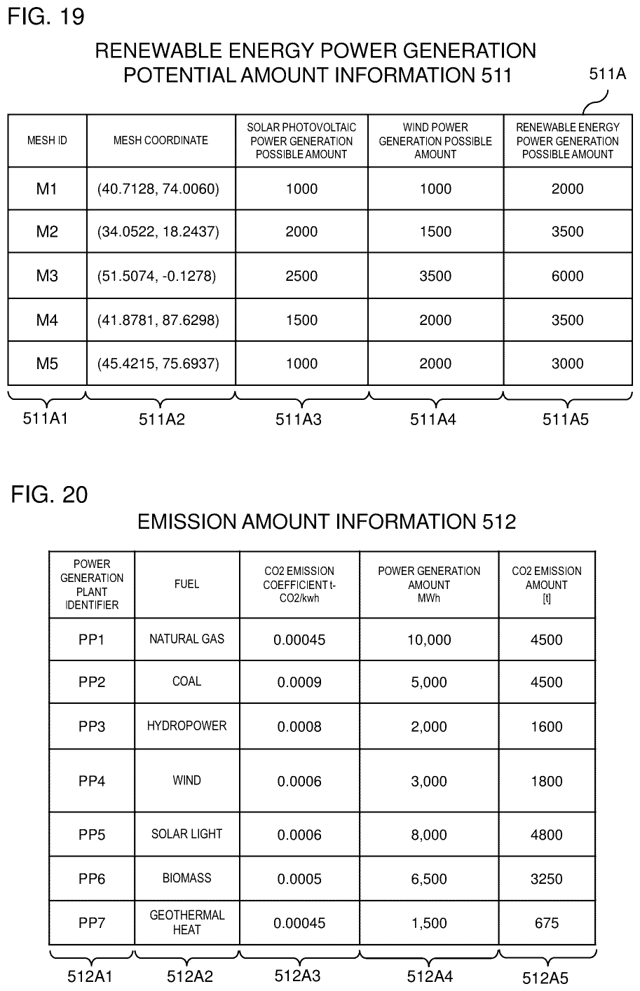

FIG. 19 is a diagram showing an example of the renewable energy power generation potential amount information 511 according to the embodiment of the disclosure. The renewable energy power generation potential amount information 511 is information related to a power generation potential of a renewable energy power supply in a region, and may include a mesh ID 511A1, a mesh coordinate 511A2, a solar photovoltaic power generation possible amount 511A3, a wind power generation possible amount 511A4, and a renewable energy power generation possible amount 511A5 as shown in FIG. 19.

The mesh ID 509A1 is information for uniquely identifying a mesh region (also referred to as a mesh area) of a target electric power system. The mesh coordinates 509A2 are information indicating geographical coordinates of a mesh region. The solar photovoltaic power generation possible amount 511A3 is information related to a potential power generation possible amount of solar photovoltaic power generation in a mesh region. The wind power generation possible amount 511A4 is information related to a potential power generation possible amount of wind generation in a mesh region. The renewable energy power generation possible amount 511A5 is a total amount of a renewable energy power generation amount in a mesh region, and is information such as a total of the solar photovoltaic power generation possible amount 511A3 and the wind power generation possible amount 511A4.

For example, for the mesh area with the mesh ID “M1”,the coordinates thereof are “(40.7128, 74.0060)”, the solar photovoltaic power generation possible amount is “1000”, the wind power generation possible amount is “1000”, and the renewable energy power generation possible amount is “2000”.

Next, the emission amount information according to the embodiment of the present disclosure will be described with reference to FIG. 20.

FIG. 20 is information showing an example of the emission amount information 512 according to the embodiment of the present disclosure. The emission amount information 512 is information indicating an emission amount of carbon dioxide emitted by existing equipment such as a power generation plant in an electric power system. As shown in FIG. 20, the emission amount information 512 may include a power generation plant identifier 512A1, a fuel 512A2, carbon dioxide emission coefficient 512A3, an electric power generation capacity 512A4, and a carbon dioxide emission amount 512A5.

The power generation plant identifier 512A1 is information for uniquely identifying a specific power generation plant in an electric power system. The fuel 512A2 is information indicating a type of fuel used for power generation by a specific power generation plant in an electric power system. The carbon dioxide emission coefficient 512A3 is information indicating an amount of carbon dioxide emitted in metric tons per kWh (Kirowatt-hour) of energy generated by a specific power generation plant in an electric power system. The electric power generation capacity 512A4 is information indicating an electric power amount generated by a specific power generation plant in an electric power system. The carbon dioxide emission amount 512A5 is information indicating an emission amount of carbon dioxide by a specific power generation plant in an electric power system.

As an example, for a power generation plant in which a power generation plant identifier is “PP1”, the fuel is “natural gas”, the carbon dioxide emission coefficient is “0.00045t-C02/kWh”, the power generation amount is “10,000 MWh”, and the carbon dioxide emission amount is “4500 t”.

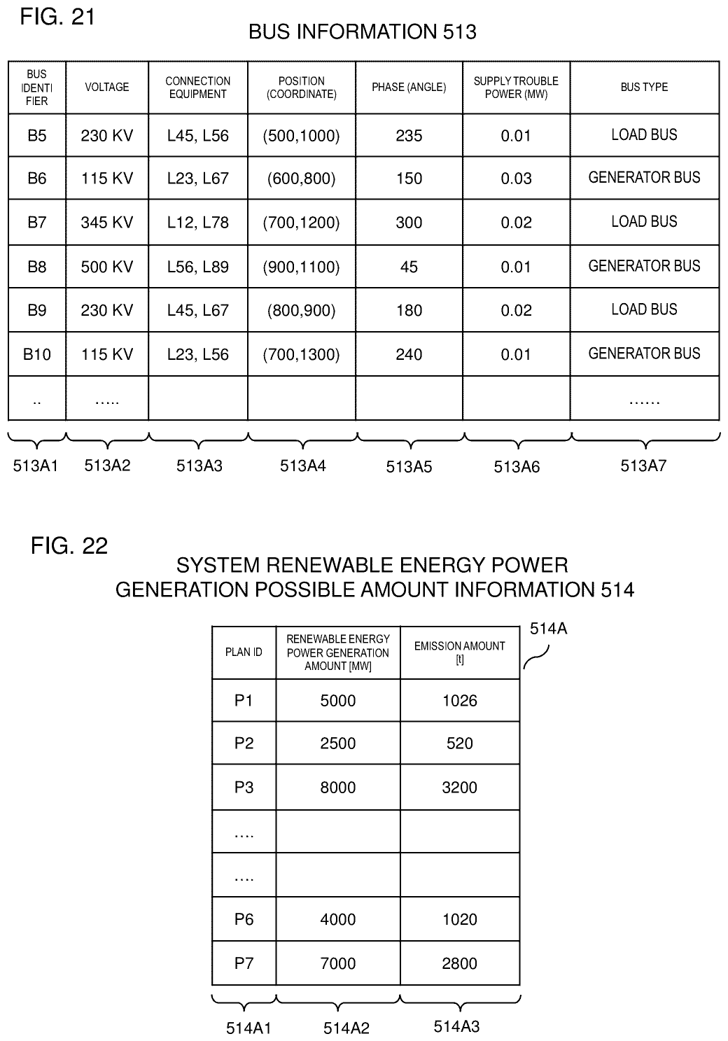

Next, electric power system bus information according to the embodiment of the present disclosure will be described with reference to FIG. 21.

FIG. 21 is a diagram showing an example of the bus information 513 of the electric power system according to the embodiment the present disclosure. The bus information 513 is information related to each bus in an electric power system, and may be acquired from the equipment specification management unit 3 shown in FIG. 2, for example. As shown in FIG. 21, the bus information 513 may include a bus identifier 513A1, a voltage 513A2, a connection equipment 513A3, a position 513A4, a phase angle 513A5, supply trouble power 513A6, and a bus type 513A7.

The bus identifier 513A1 is information for uniquely identifying a specific bus in an electric power system. The voltage 513A2 is information indicating a voltage on a specific bus in an electric power system. The connection equipment 513A3 is information for uniquely identifying equipment such as a power transmission line connected to a specific bus in an electric power system. The position 513A4 is information indicating coordinates defining a geographical position of a specific bus in an electric power system. The phase angle 513A5 is information indicating a phase angle of a specific bus in an electric power system, which is used to determine a direction of a power flow and a limit of voltage stability. The supply trouble power 513A6 is information indicating supply trouble power in a specific bus in an electric power system in a predetermined equipment failure state. The bus type 513A7 is information indicating whether a specific bus in an electric power system is a power generation bus, a load bus, or a slack bus.

As an example, it is indicated that a bus with a bus identifier “B5” has a voltage of “230 KV”, is connected to the equipment “L45” and “L56”, is located at the coordinates of “(500,1000)”, has the phase angle of “235 degrees”, has the supply trouble power of “0.01 MW”, and has the bus type of “load bus”.

FIG. 22 is a diagram showing an example of the system renewable energy power generation possible amount information 514 according to the embodiment of the present disclosure. The system renewable energy power generation possible amount information 514 is information indicating a maximum renewable energy power generation amount that can be accepted by each system plan of the electric power system, and is generated by the above-described system renewable energy power generation possible amount evaluation process 1400. As shown in FIG. 22, a plan identifier 514A1, a renewable energy power generation amount 514A2, and an emission amount 514A3 may be included.

The plan identifier 514A1 is information for uniquely identifying a specific system plan. The renewable energy power generation amount 514A2 is information indicating a maximum power generation amount that can be generated by a new renewable energy power supply while satisfying a predetermined electric power system reliability standard. The emission amount 514A3 is information indicating an emission amount of greenhouse gases emitted before the completion of the plan when a specific system plan is implemented.

As an example, for the specific system plan with the plan identifier “P1”, the renewable energy power generation amount is “5000” MW and the emission amount is “1026” t.

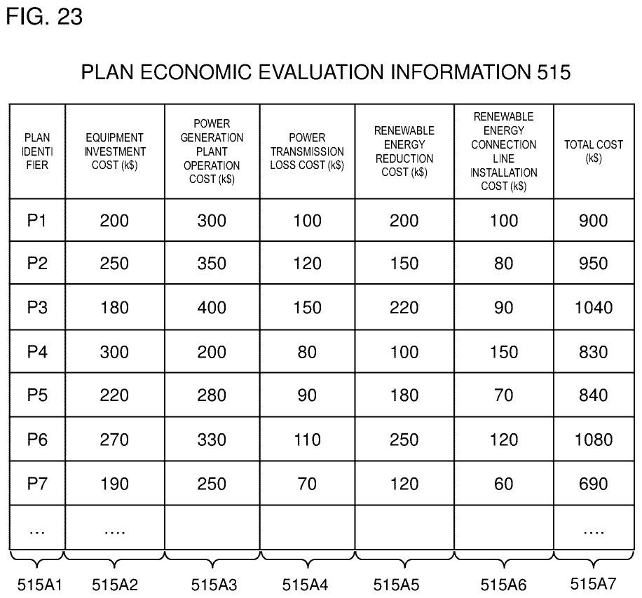

Next, the plan economic evaluation information according to the embodiment of the present disclosure will be described with reference to FIG. 23.

FIG. 23 is information showing an example of the plan economic evaluation information 515 according to the embodiment of the present disclosure. The plan economic evaluation information 515 is information indicating various costs for performing the plan for each electric power system plan generated by the electric power system management unit according to the embodiment of the present disclosure. As shown in FIG. 23, the plan economic evaluation information 515 may include a plan identifier 515A1, an equipment investment cost 515A2, a power generation plant operation cost 515A3, a power transmission loss cost 515A4, a renewable energy reduction cost 515A5, a renewable energy connection line installation cost 515A6, and a total cost 515A7.

The plan identifier 515A1 is information for identifying a specific electric power system plan. The equipment investment cost 515A2 is information indicating a cost for installing new equipment. The power generation plant operation cost 515A3 is information indicating a cost for generating and supplying electric power when a specific electric power system plan is performed. The power transmission loss cost 515A4 is information indicating a cost due to a power transmission loss generated when electric power is transmitted. The renewable energy reduction cost 515A5 is information indicating a cost due to reduction of the renewable energy power generation. The renewable energy connection line installation cost 515A6 is information indicating a cost for installing equipment for connecting a renewable energy power supply to an electric power system. The total cost 515A7 is information indicating a total of individual costs.

As an example, for the electric power system plan with the plan identifier “P1”, the equipment investment cost is “$200k”, the power generation plant operation cost is “$300k”, the power generation loss cost is “$100k”, the renewable energy reduction cost is “$200k”, the re-connection line equipment installation cost is “$100k”, and the total cost is “$900k”.

The electric power system management unit according to the embodiment of the present disclosure described above generates a future-proof and reliability-compliant electric power system plan. Thereafter, a plan area is divided into mesh areas, and a power generation potential amount by a renewable energy power supply is calculated using information on solar radiation and wind in each area. Thereafter, assuming that each mesh is connected to a closest bus, the power generation potential amount of the mesh is integrated to calculate the power generation potential amount of each bus. Finally, for each system plan, economic evaluations such as a system renewable energy power generation possible amount and an emission amount of the system plan can be calculated by an optimization calculation for the purpose of maximizing a renewable energy power generation amount (that is, minimizing the emission amount) with a renewable energy power generation potential amount as a maximum value.

As described above, according to the system renewable energy power generation possible amount and the emission amount information related to the generated system plan, a maximum possible amount of the renewable energy power supply in each possible system plan of the electric power system can be calculated. Further, among these system plans, it is possible to easily determine which of the system plans has the maximum possible amount of the renewable energy power supply in the future and can accept the maximum number of the renewable energy power supply connection requests from a power generation company. In addition, it is possible to easily determine which of the system plans can conform to the environmental standard.

Accordingly, it is possible to reduce an economic burden on a business operator who takes charge of a service of an electric power system, such as a power generation business operator or a power transmission and distribution business operator.

As described above, the electric power system management unit according to the embodiment of the present disclosure includes the following aspects.

### Aspect 1

An electric power system management system includes:
an electric power system management device configured to generate an electric power system plan for an electric power system; and
a user terminal connected to the electric power system management device via a communication network,
the electric power system management device includes a processor, a memory, and a storage unit,
the storage unit includes
existing equipment information indicating existing equipment in a plan target region of the electric power system,
new equipment information indicating a candidate of new equipment in the plan target region of the electric power system,
equipment failure information indicating a situation of an equipment failure that occurs in the electric power system,
electric power supply scenario information indicating a prediction of an electric power supply to the electric power system,
electric power demand scenario information indicating a prediction of an electric power demand to the electric power system,
renewable energy connection request information indicating a renewable energy power supply requested to be connected to the electric power system,
emission amount information indicating an emission amount of a greenhouse gas by the electric power system,
electric power system bus information indicating an existing bus in the electric power system, and
region feature information indicating a feature of the plan target region, and
the memory includes processing instructions for causing the processor to function as
a system plan generation unit that generates system plan information indicating an electric power system equipment plan satisfying a predetermined electric power supply constraint and satisfying a predetermined realizability constraint in a target period based on the existing equipment information, the new equipment information, the equipment failure information, the electric power supply scenario information, the electric power demand scenario information, and the renewable energy connection request information,
a renewable energy power generation potential amount calculation unit that divides the plan target region into a plurality of mesh areas and analyzes the region feature information related to each mesh area to generate renewable energy power generation potential amount information indicating an electric power amount that is allowed to be generated by a renewable energy power supply in each mesh area,
a renewable energy power generation potential amount bus integration unit that integrates, based on the system plan information, the electric power system bus information, and the renewable energy power generation potential amount information, a power generation potential amount when the renewable energy power supply is connected to a bus satisfying a predetermined distance standard for each mesh area, and calculates the power generation potential amount of the bus, and
a system renewable energy power generation possible amount evaluation unit that generates, based on the emission amount information and the power generation potential amount of the bus, system renewable energy power generation possible amount information indicating a system renewable energy power generation possible amount of the system plan and an emission amount according to the system plan by performing an optimization calculation to maximize the renewable energy power generation amount for the system plan in the system plan information, and outputs the system renewable energy power generation possible amount information to the user terminal.

### Aspect 2

In the electric power system management system according to Aspect 1,
the system plan generation unit
determines, based on the equipment failure information, a contingency level indicating the situation of the equipment failure to be considered in the system plan,
generates, based on the existing equipment information, the new equipment information, and the renewable energy connection request information, an update equipment candidate indicating a combination that allows removal of existing equipment and installation of new equipment corresponding to a renewable energy connection request indicated in the renewable energy connection request information,
calculates a power transmission capacity of the update equipment candidate by executing a predetermined power flow calculation on the update equipment candidate based on the contingency level, and
when the calculated power transmission capacity of the update equipment candidate satisfies the predetermined electric power supply constraint and the update equipment candidate satisfies the predetermined realizability constraint, generates, based on the update equipment candidate, the system plan information indicating a system plan for supporting a determination of an appropriate timing and a location for the installation of the update equipment candidate and the removal of the existing equipment while reducing various costs caused in operation of the electric power system.

### Aspect 3

In the electric power system management system according to Aspect 1 or 2,
the region feature information includes weather information indicating solar radiation, a wind volume, and a wind direction in the plan target region of the electric power system, and
land information indicating soil quality, topography, a land use, and an infrastructure in the plan target region of the electric power system.

### Aspect 4

In the electric power system management system according to Aspect 3,
the renewable energy power generation potential amount calculation unit
divides the plan target region into the plurality of mesh areas,
calculates a total power generation potential amount for each mesh area based on the weather information included in the region feature information,
calculates a matching ratio, which is a ratio matching renewable energy power generation, for each mesh area based on the land information included in the region feature information,
calculates, for each mesh area, an equipment introducible ratio of each mesh by multiplying the matching ratio by an equipment introduction density predicted based on the system plan information, and
generates the renewable energy power generation potential amount information indicating a renewable energy power generation potential amount for each mesh area by multiplying the equipment introducible ratio of the mesh by the total power generation potential amount of the mesh.

### Aspect 5

In the electric power system management system according to Aspect 4,
the renewable energy power generation potential amount bus integration unit
calculates a central coordinate of each mesh area,
identifies a target mesh area and a target bus satisfying the predetermined distance standard based on the electric power system bus information, the system plan information, and the calculated central coordinate of each mesh area, and
integrates the renewable energy power generation potential amount of the identified target mesh area based on the renewable energy power generation potential amount information, and calculates the power generation potential amount of the bus by setting an integrated value as the power generation potential amount of the target bus.

### Aspect 6

In the electric power system management system according to Aspects 1 to 5,
the system renewable energy power generation possible amount evaluation unit
corrects the system plan information based on the electric power generation potential amount of the bus to generate corrected system plan information indicating a case in which a renewable energy simulated generator corresponding to the electric power generation potential amount of the bus is connected to the bus,
defines, based on the corrected system plan information, an objective function for maximizing the renewable energy power generation amount while satisfying a predetermined electric power transmission capacity constraint and a predetermined electric power generation capacity constraint,
calculates a maximum value of the renewable energy power generation amount while satisfying the predetermined electric power transmission capacity constraint and the predetermined electric power generation capacity constraint by solving the objective function,
calculates, based on the emission amount information and the renewable energy power generation amount, an emission amount according to the corrected system plan information, and
generates the system renewable energy power generation possible amount information indicating the maximum value of the renewable energy power generation amount and the emission amount, and outputs, to the user terminal, together with the corrected system plan information.

### Aspect 7

In the electric power system management system according to Aspect 6,
the system renewable energy power generation possible amount evaluation unit
generates, for each system plan in the corrected system plan information, plan economic evaluation information indicating s costs for implementing the plan, and outputs the plan economic evaluation information to the user terminal.

### REFERENCE SIGNS LIST

1: electric power system management device
2: client terminal
3: equipment specification management unit
4: geographical information management unit
5: renewable energy introduction management unit
6: communication network
10: processor
20: memory
30: storage unit
40: internal bus
50: input unit
60: output unit
150: electric power system management application
200: electric power system management system
201: system plan generation unit
202: renewable energy power generation potential amount calculation unit
203: renewable energy power generation potential amount bus integration unit
204: system renewable energy power generation possible amount evaluation unit
501: existing equipment information
502: new equipment information
503: equipment failure information
504: electric power demand scenario information
505: electric power supply scenario information
506: renewable energy connection request information
507: wind information
508: solar radiation information
509: land information
510: system plan information
511: renewable energy power generation potential amount information
512: emission amount information
513: bus information
514: system renewable energy power generation possible amount information
515: plan economic evaluation information

1. An electric power system management system comprising:
an electric power system management device configured to generate an electric power system plan for an electric power system; and
a user terminal connected to the electric power system management device via a communication network, wherein
the electric power system management device includes a processor, a memory, and a storage unit,
the storage unit includes
existing equipment information indicating existing equipment in a plan target region of the electric power system,
new equipment information indicating a candidate of new equipment in the plan target region of the electric power system,
equipment failure information indicating a situation of an equipment failure that occurs in the electric power system,
electric power supply scenario information indicating a prediction of an electric power supply to the electric power system,
electric power demand scenario information indicating a prediction of an electric power demand to the electric power system,
renewable energy connection request information indicating a renewable energy power supply requested to be connected to the electric power system,
emission amount information indicating an emission amount of a greenhouse gas by the electric power system,
electric power system bus information indicating an existing bus in the electric power system, and
region feature information indicating a feature of the plan target region, and
the memory includes processing instructions for causing the processor to function as
a system plan generation unit that generates system plan information indicating an electric power system equipment plan satisfying a predetermined electric power supply constraint and satisfying a predetermined realizability constraint in a target period based on the existing equipment information, the new equipment information, the equipment failure information, the electric power supply scenario information, the electric power demand scenario information, and the renewable energy connection request information,
a renewable energy power generation potential amount calculation unit that divides the plan target region into a plurality of mesh areas and analyzes the region feature information related to each mesh area to generate renewable energy power generation potential amount information indicating an electric power amount that is allowed to be generated by a renewable energy power supply in each mesh area,
a renewable energy power generation potential amount bus integration unit that integrates, based on the system plan information, the electric power system bus information, and the renewable energy power generation potential amount information, a power generation potential amount when the renewable energy power supply is connected to a bus satisfying a predetermined distance standard for each mesh area, and calculates the power generation potential amount of the bus, and
a system renewable energy power generation possible amount evaluation unit that generates, based on the emission amount information and the power generation potential amount of the bus, system renewable energy power generation possible amount information indicating a system renewable energy power generation possible amount of the system plan and an emission amount according to the system plan by performing an optimization calculation to maximize the renewable energy power generation amount for the system plan in the system plan information, and outputs the system renewable energy power generation possible amount information to the user terminal.

2. The electric power system management system according to claim 1, wherein
the system plan generation unit
determines, based on the equipment failure information, a contingency level indicating the situation of the equipment failure to be considered in the system plan,
generates, based on the existing equipment information, the new equipment information, and the renewable energy connection request information, an update equipment candidate indicating a combination that allows removal of existing equipment and installation of new equipment corresponding to a renewable energy connection request indicated in the renewable energy connection request information,
calculates a power transmission capacity of the update equipment candidate by executing a predetermined power flow calculation on the update equipment candidate based on the contingency level, and
when the calculated power transmission capacity of the update equipment candidate satisfies the predetermined electric power supply constraint and the update equipment candidate satisfies the predetermined realizability constraint, generates, based on the update equipment candidate, the system plan information indicating a system plan for supporting a determination of an appropriate timing and a location for the installation of the update equipment candidate and the removal of the existing equipment while reducing various costs caused in operation of the electric power system.

3. The electric power system management system according to claim 1, wherein
the region feature information includes
weather information indicating solar radiation, a wind volume, and a wind direction in the plan target region of the electric power system, and
land information indicating soil quality, topography, a land use, and an infrastructure in the plan target region of the electric power system.

4. The electric power system management system according to claim 3, wherein
the renewable energy power generation potential amount calculation unit
divides the plan target region into the plurality of mesh areas,
calculates a total power generation potential amount for each mesh area based on the weather information included in the region feature information,
calculates a matching ratio, which is a ratio matching renewable energy power generation, for each mesh area based on the land information included in the region feature information,
calculates, for each mesh area, an equipment introducible ratio of each mesh by multiplying the matching ratio by an equipment introduction density predicted based on the system plan information, and
generates the renewable energy power generation potential amount information indicating a renewable energy power generation potential amount for each mesh area by multiplying the equipment introducible ratio of the mesh by the total power generation potential amount of the mesh.

5. The electric power system management system according to claim 4, wherein
the renewable energy power generation potential amount bus integration unit
calculates central coordinates of each mesh area,
identifies a target mesh area and a target bus satisfying the predetermined distance standard based on the electric power system bus information, the system plan information, and the calculated central coordinate of each mesh area, and
integrates the renewable energy power generation potential amount of the identified target mesh area based on the renewable energy power generation potential amount information, and calculates the power generation potential amount of the bus by setting an integrated value as the power generation potential amount of the target bus.

6. The electric power system management system according to claim 1, wherein
the system renewable energy power generation possible amount evaluation unit
corrects the system plan information based on the electric power generation potential amount of the bus to generate corrected system plan information indicating a case in which a renewable energy simulated generator corresponding to the electric power generation potential amount of the bus is connected to the bus,
defines, based on the corrected system plan information, an objective function for maximizing the renewable energy power generation amount while satisfying a predetermined electric power transmission capacity constraint and a predetermined electric power generation capacity constraint,
calculates a maximum value of the renewable energy power generation amount while satisfying the predetermined electric power transmission capacity constraint and the predetermined electric power generation capacity constraint by solving the objective function,
calculates, based on the emission amount information and the renewable energy power generation amount, an emission amount according to the corrected system plan information, and
generates the system renewable energy power generation possible amount information indicating the maximum value of the renewable energy power generation amount and the emission amount, and outputs, to the user terminal, the system renewable energy power generation possible amount information together with the corrected system plan information.

7. The electric power system management system according to claim 6, wherein
the system renewable energy power generation possible amount evaluation unit
generates, for each system plan in the corrected system plan information, plan economic evaluation information indicating various costs for implementing the system plan, and outputs the plan economic evaluation information to the user terminal.

8. An electric power system management program executed in an electric power system management device that generates an electric power system plan for an electric power system, wherein
the electric power system management device includes
a processor,
a memory storing a processing instruction, and
a storage unit,
the storage unit includes
existing equipment information indicating existing equipment in a plan target region of the electric power system,
new equipment information indicating a candidate of new equipment in the plan target region of the electric power system,
equipment failure information indicating a situation of an equipment failure that occurs in the electric power system,
electric power supply scenario information indicating a prediction of an electric power supply to the electric power system,
electric power demand scenario information indicating a prediction of an electric power demand to the electric power system,
renewable energy connection request information indicating a renewable energy power supply requested to be connected to the electric power system,
emission amount information indicating an emission amount of a greenhouse gas by the electric power system,
electric power system bus information indicating an existing bus in the electric power system, and
region feature information indicating a feature of the plan target region, and
the processing instruction stored in the memory causes the processor to execute:
a step of generating system plan information indicating an electric power system equipment plan satisfying a predetermined electric power supply constraint and satisfying a predetermined realizability constraint in a target period based on the existing equipment information, the new equipment information, the equipment failure information, the electric power supply scenario information, the electric power demand scenario information, and the renewable energy connection request information;
a step of dividing the plan target region into a plurality of mesh areas and analyzing the region feature information related to each mesh area to generate renewable energy power generation potential amount information indicating an electric power amount that is allowed to be generated by a renewable energy power supply in each mesh area;
a step of integrating, based on the system plan information, the electric power system bus information, and the renewable energy power generation potential amount information, a power generation potential amount when the renewable energy power supply is connected to a bus satisfying a predetermined distance standard for each mesh area, and calculating the power generation potential amount of the bus; and
a step of generating, based on the emission amount information and the power generation potential amount of the bus, system renewable energy power generation possible amount information indicating a system renewable energy power generation possible amount of the system plan and an emission amount according to the system plan by performing an optimization calculation to maximize the renewable energy power generation amount for the system plan in the system plan information, and outputting the system renewable energy power generation possible amount information.
